(19) United States
(12) Patent Application Publication
(10) Pub. No.: US 2003/0123072 A1
(43) Pub. Date: Jul. 3, 2003

(54) System and method for color transformation using standardized device profiles

(76) Inventor: Conernelis Adrianus Maria Spronk, IJsselstein (NL)

Correspondence Address: COOLEY GODWARD, LLP, 3000 EL CAMINO REAL, 5 PALO ALTO SQUARE, PALO ALTO, CA, 94306, US

(21) Appl. No.: 10/284,604

(22) Filed: Oct. 30, 2002

Related U.S. Application Data
(60) Provisional application No. 60/336,901, filed on Nov. 2, 2001.

(51) Int. Cl. B41J 1/00; G06F 15/00

(52) U.S. Cl. 358/1.9

(57) ABSTRACT

A method for generating a color space transformation table configured to convert an input color defined in a device-dependent color space of an imaging device into an output color defined in a device-independent color space is disclosed herein. The method comprises printing a plurality of sets of primary color targets using each of a corresponding plurality of primary colorants of the device-dependent color space. The primary color targets are printed by the imaging device at a selected number of coverage percentages. Target spectra of the primary color targets included within each of the plurality of sets of primary color targets are measured in order to create a plurality of initial spectra values. A plurality of additional spectra values corresponding to combinations of the primary color targets are then calculated. Each of these additional spectra values are based upon a combination of at least two of the initial spectra values. The initial spectra values and the additional spectra values are transformed into a set of device independent color values defined in the device-independent color space. Finally, the device-independent color values are inserted into a color table arranged so as to establish a correspondence between ones of the device-independent color values and device-dependent color values defined with respect to the device-dependent color space.

### CROSS-REFERENCE TO RELATED APPLICATIONS

This application claims priority under 35 U.S.C. §119(e) to U.S. Provisional Application No. 60/336,901, filed Nov. 2, 2001, the entire content of which is hereby incorporated by reference.

### FIELD OF THE INVENTION

The invention relates to the general field of color printing, and in particular to methods and apparatus for determining and compensating for the unique color characteristics of color printers in order to, for example, enable a local color printer to generate a color proof of an image prior to printing of such image using a printing press or the like.

### BACKGROUND OF THE INVENTION

Color image processing systems are often comprised of an input device (e.g., a scanner), an image manipulation device (e.g., a workstation) and one or more output devices (e.g., monitors, ink jet printers, color presses, etc.). Within such systems, consistency of color reproduction across system components is desirable. For example, it is desired that a printed image have the same colors as a version seen on a CRT monitor. Similarly, it is preferred that the colors of an image nearly visually match when printed or displayed using different output devices. It is also desirable to attain similar consistency of color reproduction when image files are transferred between different color image processing systems.

Although consistency of color reproduction among output devices is desired, this objective is complicated by the fact that color rendering is effected dissimilarly within different types of output devices. For example, in “additive” devices which emit light to in order create color (e.g., CRT displays) the primary colors red, green, and blue (“RGB”) are mixed to create all of the colors capable of being displayed by the device. The set of such displayable colors is commonly referred to as the device's “color gamut”. In addition, devices utilizing reflected light to render color (e.g., printers) generally use the set of subtractive color mixing primaries cyan (“C”), magenta (“M”) and yellow (“Y”) to obtain a wide color gamut.

Theoretically, for additive color processes mixing red, green, and blue light in various combinations can produce any color. For example, cyan is a combination of green and blue and magenta is a combination of red and blue. Black may be considered the absence of any primary color (e.g., red, green, or blue), while white is the result of mixing all three primary colors.

In subtractive printing process, inks are printed on white paper disposed to substantially completely reflect red, green, and blue. Rather than mixing the primary colors red, green and blue to produce desired color, filters or inks are produced in order to selectively filter individual primary colors. This filtering process is effected by employing filtering colors comprising the complements of the primary colors. Specifically, cyan, magenta, and yellow are the primary colors in the subtractive color system which respectively comprise the complements of red, green and blue. Accordingly, in theory a printer could be capable of printing any color with only three colors of ink: cyan (C), magenta (M) and yellow (Y). Although black could potentially be produced by depositing a combination of cyan, magenta, and yellow, in practice the result may be dark brown rather than black. As a consequence, conventional color printers typically utilize black ink as well as the other subtractive primary colors in order to increase the gamut of the color set.

If it is desired that an image displayed using a light emission device (e.g., an RGB image) appear substantially similar to a print made by a color printer, it is necessary to transform the image data from the color space of the emissive device to the color space of the color printer. Such transformation involves mapping image data from an input “color space” (e.g., the RGB color space) to an “output color space” (e.g., the CMY color space). In this regard the source or input image data may be deemed to initially reside in an input color space, and to then exist in an output color space after transformation. The gamut of colors capable of being represented within the input image data defines the input color space, while the range of colors capable being produced by the output imaging device corresponds to the output color space. Although in this sense the input and output color spaces may be said to be “device dependent”, so called “device-independent” color spaces have also been developed based upon the response of the human visual system.

One such device-independent color space has been developed by the Commission Internationale L'Eclairge (International Commission of Lighting or “CIE”). The CIE has developed a matrix transform used to define color values with a color space called CIE XYZ or XYZ. One device independent color space derived from the XYZ color space is known generally as “CIELAB” or “L*a*b*”. This color space utilizes three coordinates (L*, a*, and b*), and is based on XYZ of the color referenced to XYZ of the light source or paper. The coordinate L* specifies the lightness; and the hue and saturation are determined from the values of a* and b*.

As part of the actual rendering of an image within a color processing system, an output device may receive a set of image color values from an image manipulation device (e.g., a computer) intended to cause the output device to produce a color within its device-dependent color space. However, in these types of color printers, the particular color printed depends not only on the set of color values received from the host computer, but also on other factors such as, for example, the output characteristics of the printer itself. For example, minor variations in individual units of a particular printer available from a given manufacturer may render slightly different color images in response to the same set of received color values. Accordingly, there will generally be variations in the colors output from printer to printer or monitor to monitor in response to the same set of color values. Accordingly, digital image data received at output color printers must typically be transformed or pre-processed so that different such devices will all render an image represented by the image color values in a similar way. In prior systems this has been effected by associating a pre-processor with each output device in order to transform the color values in accordance with a profile characterizing each such device. In this way it is attempted to ensure that the colors produced by a given device match those generated using other devices.

In an attempt to promote consistency of color representation, efforts have been made to calibrate output devices to particular standards. For example, it has been endeavored to calibrate output devices relative to the PANTONE color system, which is comprised of a set of reference inks. Although PANTONE colors are not the same as those utilized by conventional color printers, those CMY values resulting in a color most closely matching a given PANTONE color have been specified. In this way the sets of CMY values corresponding to the PANTONE colors may be considered to define a particular device independent color standard.

In order calibrate an output device to a particular standard such as PANTONE, it is currently necessary to input the CMY values corresponding to a desired PANTONE color. An output printed by the device using these given values is then examined and compared to the desired PANTONE color. If a sufficiently close color match is not obtained, one or more of the color values are typically varied on a trial and error basis until a selected combination results in an output sufficiently close to the desired PANTONE color. After the proper color values are determined by this trial and error process, the system can be recalibrated using those values to achieve the desired output. However, such trial and error processes are extremely tedious, time consuming and inefficient.

On the other hand, it may not always be desired that an output device be calibrated with respect to a particular standard. In this regard methods are being developed to achieve device independent color using an intermediate, independent color space such as CIELAB. That is, a color input device such as a monitor that uses a device dependent color space such as RGB will be mapped to a device independent color space such as L*a*b*, and will then be transformed to another device dependent color space such as CMY. However, this process involves the use of complex transformation algorithms and procedures. Moreover, the creation of such transformations typically involves generating set of color patches by printing and measuring patches of printer colors distributed throughout the color space. The color of each patch is measured using a spectrophotometer to determine color in terms of XYZ values. The measured colors are used to build one or more look-up-tables relating the device independent color space to the device-dependent color space of the device of interest. In general, the accuracy of this approach is directly related to the number of patches created. However, creating and measuring a large number of patches can be a time-consuming and expensive process, and leads to establishment of correspondingly large look-up tables consuming significant amounts of memory. Moreover, these difficulties can be dramatically exacerbated as the number of colorants utilized by the device is increased.

In addition to being able to accurately characterize the color reproduction properties and behavior of an output device, it is also of importance to be able to accurately predict the color of an overprint comprised of a mixture of colorants printed or displayed by the output device. For example, there has been much effort to develop ways to accurately predict the appearance of such images when printed on a substrate such as paper or film using halftoning (i.e., “screening”) techniques. As is known, halftoning is the process of creating the illusion of a continuous tone image using a binary output device capable of only depositing/displaying or not depositing/displaying colorant at any image location. In this regard digital color printers typically produce images composed of arrays of ink dots which, when viewed at a distance, appear as a solid color or “halftone”. The fractional coverage of the dots in such a halftone is commonly termed the “dot density” or coverage percentage” associated with the halftone color. For example, when ink dots are spaced so that approximately 50% of the area of an ink pattern is covered by ink, the dot density is said to be 50%. For color printing, several images (“separations”) are produced in the primary ink colorants used to print in color, and overlaid in printing. For typical CMY printing, the separate cyan, magenta and yellow images are separately halftoned.

A primary measure of the quality of a multi-colored printed image is the extent to which the colors of the image match desired colors or the colors of a reference image. Thus, the quality of an image comprised of multiple colors is at least partly determined by the dot density of each of the constituent primary color images forming the composite multiple color image. Consequently, inaccuracies in the dot density of a primary color image printed by the output color printer may degrade the quality of the composite color image. One type of such an inaccuracy tends to arise through a phenomenon known as “dot gain”. This relates to the observation that the dot density of the printing plate does not always accurately correspond to the dot density of the image actually printed. In many cases the dot density of the printed image is larger than the coverage percentage of the printing plate as a result of, for example, the spreading of ink over the substrate or paper upon which the image is printed. Unfortunately, this generally results in degradation of the appearance of the printed image.

### SUMMARY OF THE INVENTION

In summary, the present invention relates in one aspect to a method for generating a color space transformation table configured to convert an input color defined in a device-dependent color space of an imaging device into an output color defined in a device-independent color space. The method comprises printing a plurality of sets of primary color targets using each of a corresponding plurality of primary colorants of the device-dependent color space. The primary color targets are printed by the imaging device at a selected number of coverage percentages. Target spectra of the primary color targets included within each of the plurality of sets of primary color targets are measured in order to create a plurality of initial spectra values. A plurality of additional spectra values corresponding to combinations of the primary color targets are then calculated. Each of these additional spectra values are based upon a combination of at least two of the initial spectra values. The initial spectra values and the additional spectra values are transformed into a set of device independent color values defined in the device-independent color space. Finally, the device-independent color values are inserted into a color table arranged so as to establish a correspondence between ones of the device-independent color values and device-dependent color values defined with respect to the device-dependent color space.

In another aspect, the present invention relates to a method for generating a color space transformation table configured to convert an input color defined in a device-independent color space into an output color defined in a device-dependent color space of an imaging device. The inventive method comprises generating a set of gray balance curves using spectral measurements of a plurality of gray balance targets printed by the imaging device. Hue, saturation and luminance behavior curves are then generated using spectral measurements of a plurality of hue color targets printed by the imaging device. A set of device-dependent color values are then derived using the hue, saturation and luminance behavior curves and the set of gray balance curves. The set of device-dependent color values are inserted into a color table designed to establish a correspondence between ones of the device-dependent color values the device-independent color values defined with respect to the device-dependent color space.

The present invention is further directed to a method of proofing an image using a color printer in the case when the image is represented by input image data defined in a device-dependent color space of a press device. The method comprises creating a press profile representative of printing characteristics of the press device. A printer profile representative of printing characteristics of the color printer is created. In this regard the printer profile may include: (1) a first color space transformation table establishing a correspondence between device-independent color values and device-dependent color values and a second color space transformation table establishing a correspondence between the device-dependent color values and the device-independent color values; and (2) at least one transverse color curve. The method also contemplates converting, using the press profile and the printer profile, the input image data into output image data provided to the color printer.

The present invention also relates to a system for transforming an input image file produced by an input device into an output image file. The system comprises an ID creator unit for generating an input device ID profile and an output device ID profile. The input device ID profile includes transformation information based upon calculated spectral values derived from combinations of target patch spectral measurements. The system further includes a raster image processor (RIP) operative to generate the output image file on the basis of the input image file, the input device ID profile and the output device ID profile.

### BRIEF DESCRIPITON OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustratively represents a color management system in which the present invention may be embodied.

FIG. 2 is a block diagrammatic representation of a color management unit of the inventive color management system.

FIG. 3 is a high-level flowchart representative of the overall process of developing a printer ID profile in accordance with an exemplary embodiment of the invention.

FIG. 4 describes generation of a CMYK to L*a*b* color space transformation table included within the printer ID profile.

FIG. 5 is a flowchart which illustrates an exemplary approach to generating a L*a*b* grid and dot gain compensation information pertinent to creation of a L*a*b* to CMYK color space transformation table incorporated within the printer ID profile.

FIG. 6 is a flowchart representative of an exemplary approach to generating a L*a*b* grid and dot gain compensation information pertinent to creation of the L*a*b* to CMYK color space transformation table incorporated within the printer ID profile.

FIG. 7 is a flowchart representative of a color correction process performed during generation of the L*a*b* to CMYK color space transformation incorporated within the printer ID profile.

FIG. 8 is a flowchart which illustratively represents a SEP color processing procedure.

FIG. 9 describes the synthesis of the printer ID profile based upon the color space transformation information created during the processing described with reference to FIGS. 4-8.

FIG. 10 illustratively depicts a high-level flowchart representative of an overall process for developing a press ID profile in accordance with an exemplary embodiment of the invention.

FIG. 11 describes generation of a CMYK to L*a*b* color space transformation table included within the press ID profile.

FIG. 12 is a flowchart illustrative of an exemplary approach to generating a L*a*b* grid and dot gain compensation information pertinent to creation of the L*a*b* to CMYK color space transformation table incorporated within the press ID profile.

FIG. 13 is a flowchart representative of a gray balance modification process pertinent to generation of the L*a*b* to CMYK color space transformation incorporated within the press ID profile.

FIG. 14 is a flowchart representative of a color correction process performed during generation of the L*a*b* to CMYK color space transformation incorporated within the press ID profile.

FIG. 15 is a flowchart which illustratively represents a SEP color processing procedure relevant to creation of the press ID profile.

FIG. 16 describes the synthesis of the press ID profile based upon the color space transformation information created during the processing described with reference to FIGS. 11-15.

FIG. 17 depicts an exemplary system in which color transformation may be effected using a raster image processor (RIP) in accordance with the present invention.

FIG. 18 provides an illustrative representation of the manner in which work flow progresses among the primary functional components of the RIP and of the relationship of such components to other system elements.

FIG. 19 provides a tabular listing of a set color separation values useful in determining a set of values in a 6-channel color system corresponding to an original set of values defined within a 4-channel color environment.

FIG. 20 graphically depicts a dot gain compensation curve generated using the ID creator unit.

FIG. 21 illustrates a mixing curve which may be utilized in connection with generation of a 6-channel transfer curve.

FIG. 22 graphically represents certain light and dark color curves useful in determining a set of values in a 6-channel color system corresponding to an original set of values defined within a 4-channel color environment.

FIG. 23 depicts a 4-channel gray balance curve generated using interpolative techniques.

FIG. 24 illustratively represents an exemplary H-Graph useful in determining hue behavior.

FIG. 25 illustratively represents an exemplary S-Graph useful in determining saturation behavior.

FIG. 26 illustratively represents an exemplary Y-Graph useful in determining luminance behavior.

### DETAILED DESCRIPTION OF THE INVENTION

### System Overview

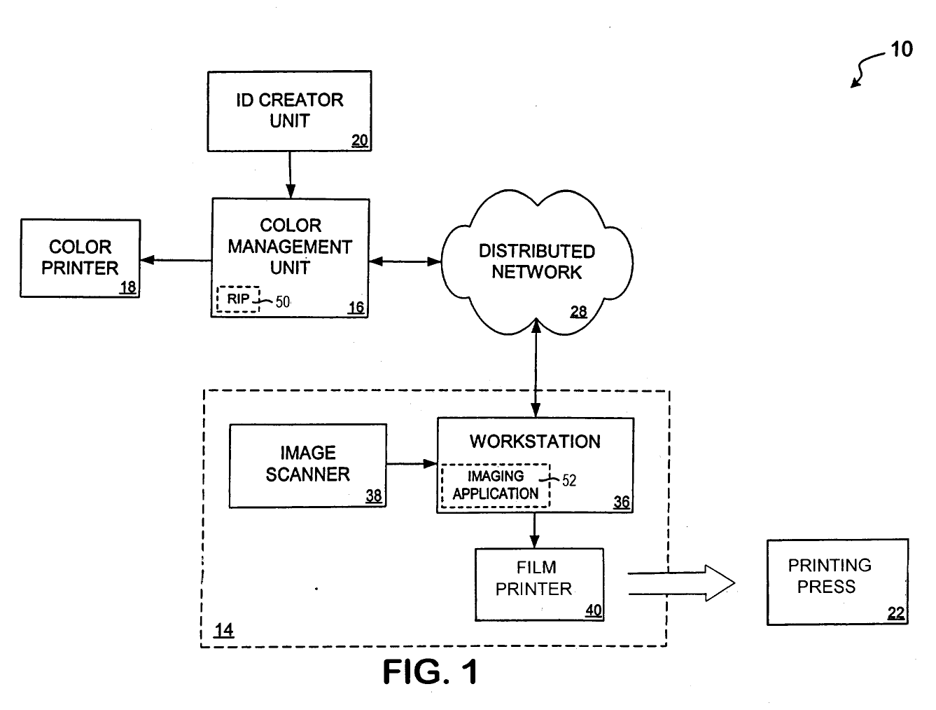

FIG. 1 illustratively represents a color management system 10 in which the present invention may be embodied. The color management system 10 includes a printing press image preparation apparatus 14, a color management unit 16, an imaging device such as a color printer 18, and an ID creator unit 20. As shown, the printing press image preparation apparatus 14 interfaces with a printing press 22 through a standard local area network (LAN) connection 24 and with the color management unit 16 through a distributed network 28 (e.g., the Internet). The color printer 18 is typically co-located with the color management unit 16 through a standard LAN connection 32.

The image preparation apparatus 14 generally includes a workstation 36 operative as an electronic image processing apparatus. The workstation 36 may receive input image data from a variety of sources, such as from an image scanner 38. During exemplary operation of the system 10, the image scanner 38 connected to the workstation 12 reads in image data from various sources (e.g., color pictures, characters, and graphic patterns), and sends image data defined in a device-dependent color space (e.g., CMYK) to the workstation 36. Upon receipt of the image data, the workstation 36 displays the image data provided by the scanner 38 to a user. This enables the user to electronically construct a desired image based upon the received image data. This image construction process, typically effected by the workstation 36 in response to user commands received through a keyboard and mouse (not shown), often involves imposing patterns and/or text over the image data received from the scanner 38.

The workstation 36 supplies data representative of the constructed image to the film printer 40 disposed to produce a set of printing film plates. Usually, printing plates for the printing press 22 are produced from the printing film plates. The printing plates are mounted on the printing press 22 and coated with the inks of the device-dependent color space of the printing press 22. The printing press is then configured to produce printed output corresponding to the image constructed by the user of the workstation 36.

The above process of producing a color print using the printing press 22 is generally relatively expensive and time consuming. As a consequence, the color management unit 16 and color printer 18 are used to print a predicted version of such a color print (i.e., a color “proof”) for the purpose for confirming the color appearance and finish of the color print prior to actual printing of the color print using by the printing press 22. To this end, image data corresponding to the image constructed by the workstation 36 is supplied to the color management unit 16. This image data may be in the form of Page Description Language (“PDL”), which describes pages of image information using positional and color information.

In accordance with one aspect of the invention invention, a raster image processor (RIP) 50 executing on the color management unit 16 utilizes a printer identification (“ID”) profile and a press ID profile in converting input image data received from the workstation 36 into the device-dependent color space of the color printer 18. After the input image data is processed by the color management unit 16 on the basis of these stored ID profiles, the resultant processed image data is supplied to the color printer 18 in order that it may print a proof of the image constructed by the workstation 36. As is described below, the printer ID profile and press ID profile are generated by the ID creator unit 20 and loaded within the color management unit 16 prior to execution of the RIP 50. The ID creator unit 20 may be realized using a personal computer or workstation programmed to execute the operations described herein.

The color management unit 16 is configured to provide the capability of maintaining control over color rendering among various devices and media such as between the printing press 22 and the color printer 18. In accordance with one aspect of the invention, this is achieved by encapsulating the color characteristics of each device in an ID profile in a unique manner. The information stored within each ID profile provides a digital representation of the relation between device driver signals (e.g., RGB or CMYK channel code values) and a device-independent color space, and vice versa. In the exemplary embodiment each device ID profile is referenced to the same device-independent color space (e.g., L*a*b*), thereby enabling image data to be translated from the color space of one device to another while simultaneously maintaining consistency of color perception. In this way the device-independent color space referenced by each profile provides a standard conduit for the communication of color values, which permits device ID profiles to provide the basis for transformation from one device-independent color space to another. This is achieved by a conceptual transformation (per the applicable ID profile) from the color space of a first device into the device-independent color space followed by a transformation into the device-dependent color space of a second device (per its device IP profile). Although the image data being processed may never actually be represented in the device-independent color space by the color management unit 16, the device-independent color space may conceptually be regarded as a convenient intermediate stage of color processing.

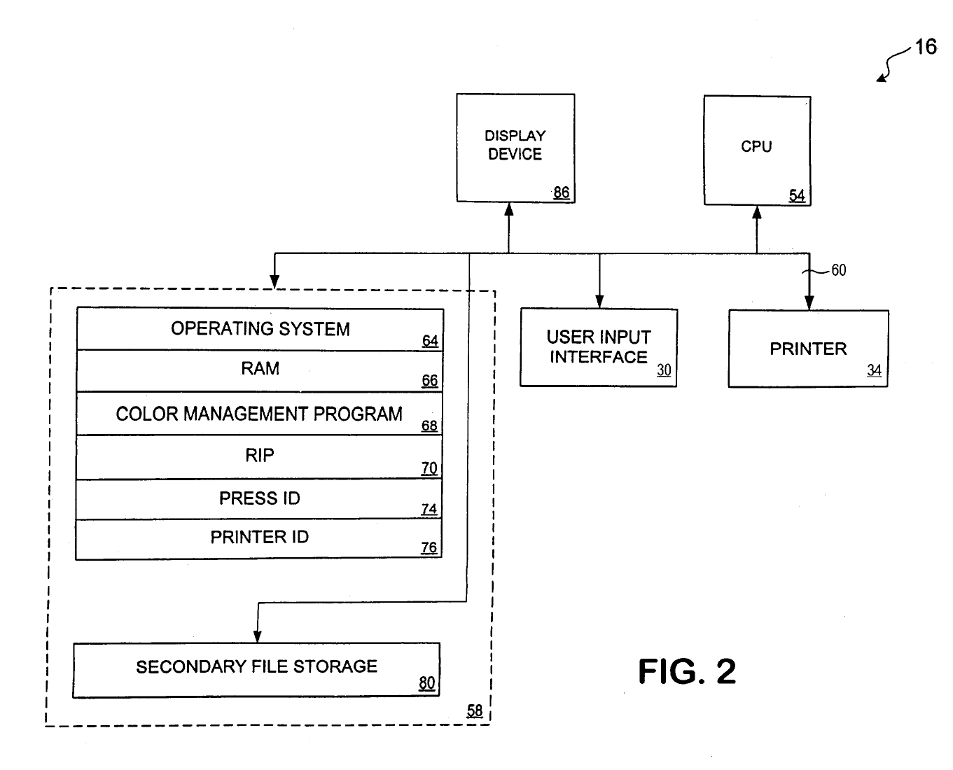

FIG. 2 is a block diagrammatic representation of the color management unit 16. Although the specific implementation of FIG. 2 is described with reference to a general-purpose computer system or workstation, the color management unit 16 may be embodied in dedicated devices such as printer servers or controllers.

Referring to FIG. 2, the color management unit 16 includes a central processing unit (“CPU”) 54 and a memory subsystem 58 in communication via a system bus 60. The memory subsystem 58 holds a copy of the operating system 64 for the unit 16, random access memory (RAM) 66, a raster image processor (“RIP”) 50, a press ID profile 74, a printer ID profile 76, and secondary file storage 80. The CPU 54 may also communicate with a number of peripheral devices via bus 60 including, for example, a user input interface 84 and a visual display device 86. The system bus 60 is representative of any mechanism disposed to permit the various components of the color management unit 16 to communicate with each other as intended. Thus, for example, the input devices and display need not be at the same location as the processor, although it is anticipated that the unit 16 will most often be implemented in the context of personal computers (PCs) and workstations.

During operation of the color management unit 16, the RIP 50 executes on the CPU 54 and transforms the PDL image data supplied from the workstation 36 into bit map data defined in the device-dependent color space of the color printer 18 (e.g., the CMYK color space). Conceptually, the 50 utilizes the press ID profile 74 to convert the PDL image data into L*a*b* data and uses the printer ID profile 76 to transform this intermediary L*a*b* data into the device-dependent color space of the color printer 18.

### Creation of Printer ID Profile

In an exemplary embodiment, the printer ID profile 76 and the press ID profile 74 utilized by the color management unit 16 are formatted consistently with the profile specifications promulgated by the International Color Consortium (“ICC”). As is described hereinafter, the present invention contemplates a unique and improved method of generating color space transformation tables included within device ID profiles such as the profiles 74 and 76. In addition, it is further contemplated that various transverse color curves and other information be stored within the ID profiles 74 and 76 in order to further facilitate the color management processes of the present invention.

By way of overview, the printer ID profile 76 includes a CMYK to L*a*b* color space transformation table, a L*a*b* to CMYK color space transformation table, a set of transverse color curves stored in a private area of the press ID profile, and a profile header. In the exemplary embodiment the printer ID profile 76 will also include a tag table and tagged element data to the extent required by the applicable specifications promulgated by the ICC (see, e.g., Specification ICC.1:2001-04).

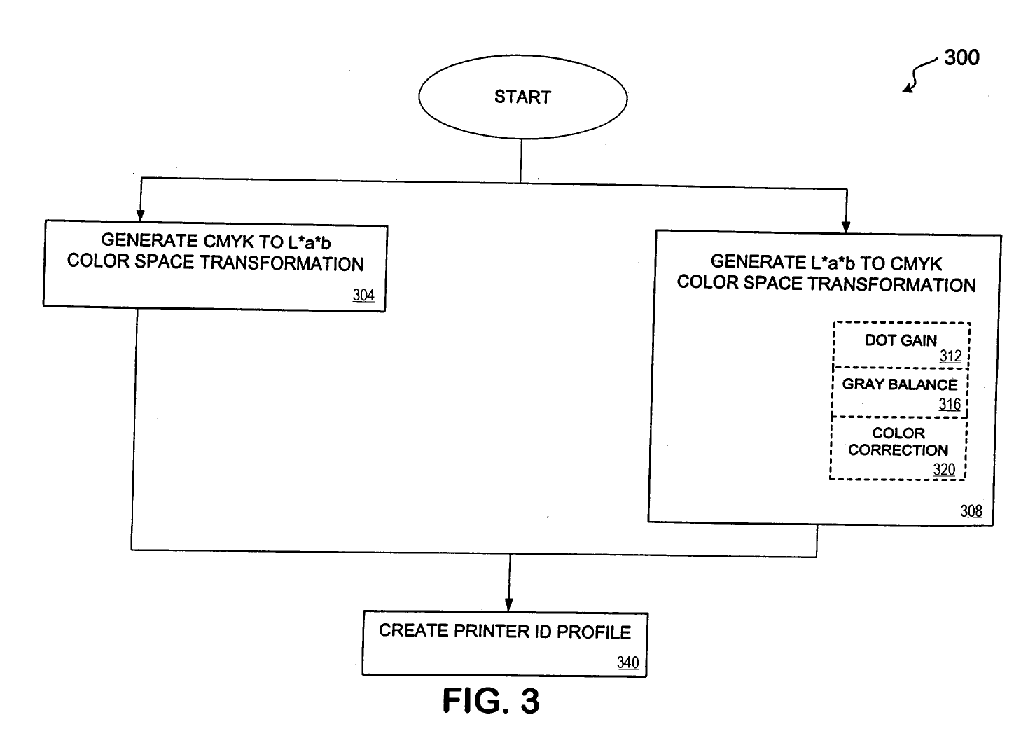

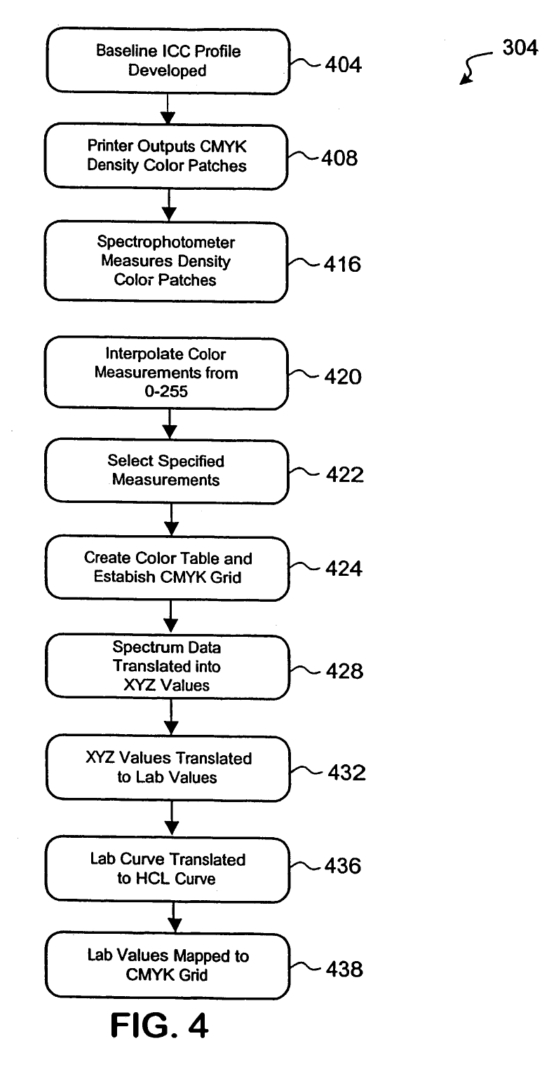

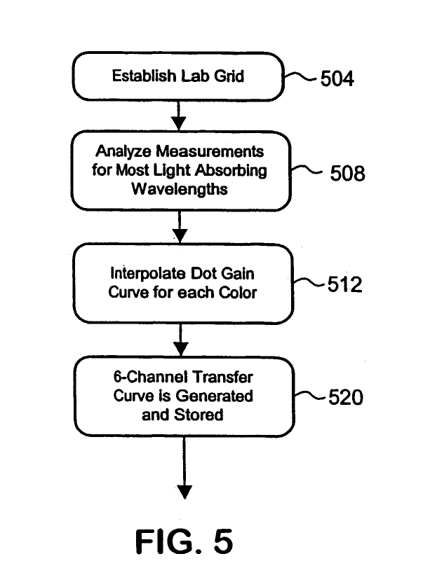

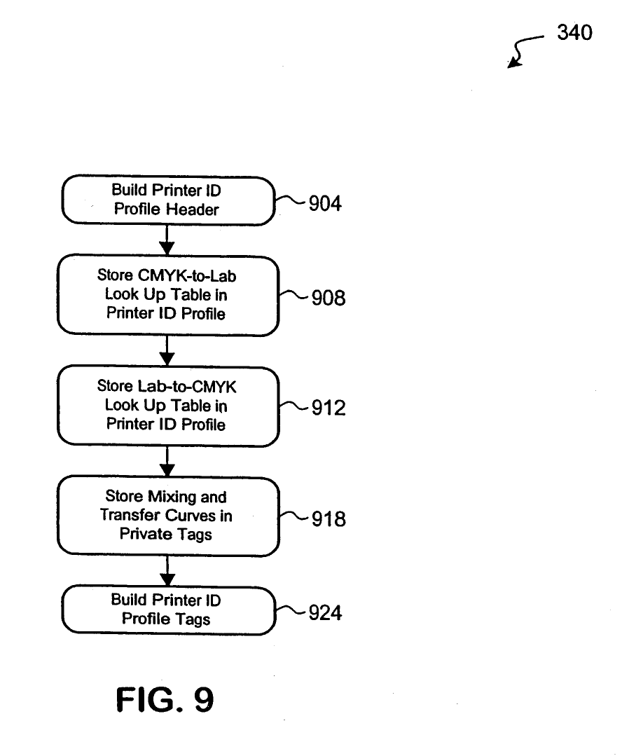

FIGS. 3-9 are flowcharts representative of an exemplary process for creating the printer ID profile 76 in accordance with one aspect of the present invention. In particular, FIG. 3 is a high-level flowchart representative of the overall process 300 of developing a printer ID profile 76 in accordance with an exemplary embodiment of the invention. Each of the activities depicted in FIG. 3 are explained in greater detail below with reference to FIGS. 4-9. Specifically, FIG. 4 describes generation of a CMYK to L*a*b* color space transformation table included within the printer ID profile 76. Similarly, FIGS. 5-8 describe generation of a L*a*b* to CMYK color space transformation table included within the printer ID profile 76. Finally, FIG. 9 describes the synthesis of the printer ID profile 76 based upon the color space transformation information created during the processing described with reference to FIGS. 4-8.

Turning now to FIG. 3, the ID creator unit 20 generates certain CMYK to L*a*b* color space transformation information in connection with creation of the printer ID profile 76 (step 304). As is described below, the ID creator unit 20 also similarly creates L*a*b* to CMYK color space transformation information (step 308). As part of this latter process, the ID creator unit 20 performs various operations such as dot gain compensation 312, gray balance adjustment 316 and color correction 320. Finally, the color space transformation information generated during the preceding steps is incorporated within and otherwise utilized in synthesizing the printer ID profile 76 (step 340).

### CMYK to L*a*b* Color Space Transformation

FIG. 4 is a flowchart illustrating an exemplary process 304 for generating CMYK to L*a*b* color space transformation information for incorporation within the printer ID profile 76. In a step 404, a baseline printer ICC profile is developed to serve as a repository for certain color space transformation data developed in the manner described hereinafter. For example, the baseline profile serves to maintain color neutrality for various CMYK-to-Lab and Lab-to-CMYK conversion tags, and includes a 6-channel mixing curve tag (described below) that is used to build certain color density (linearization) targets.

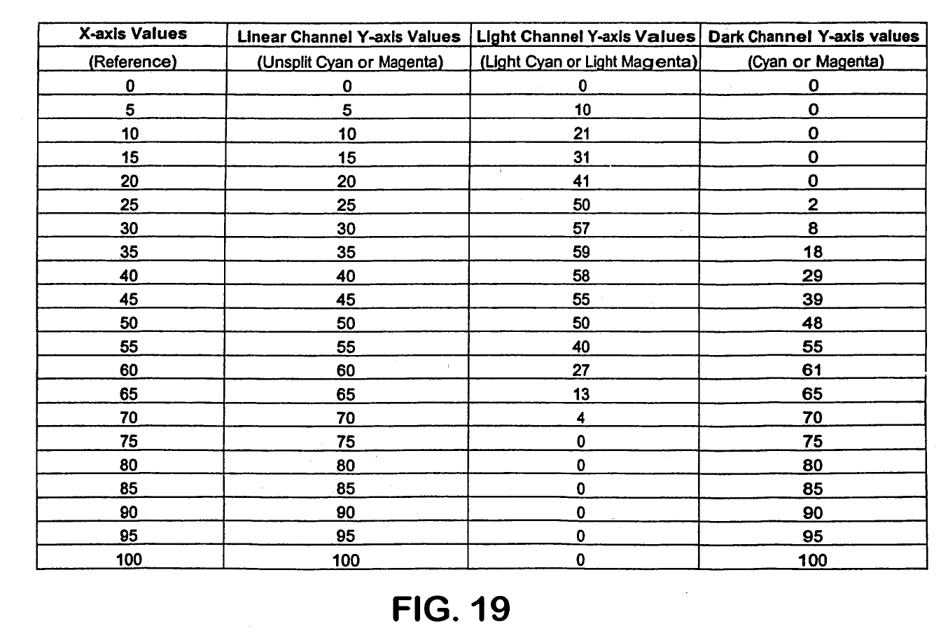

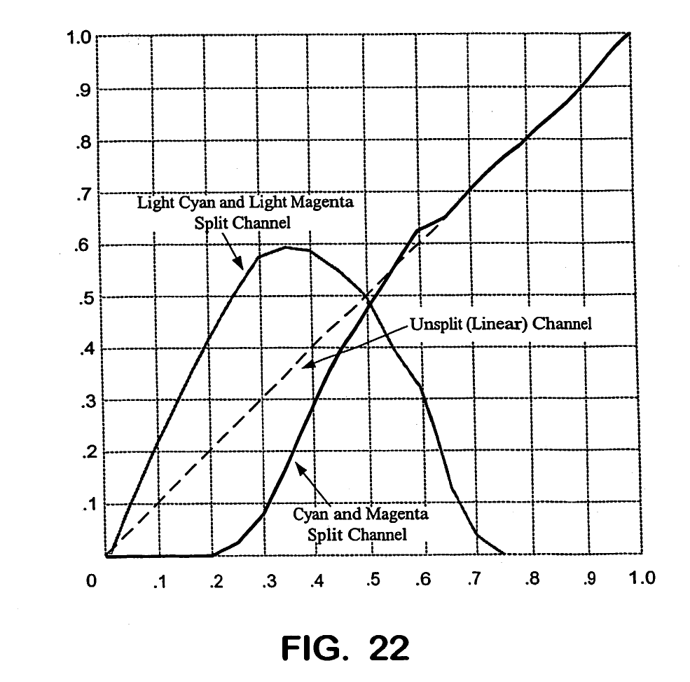

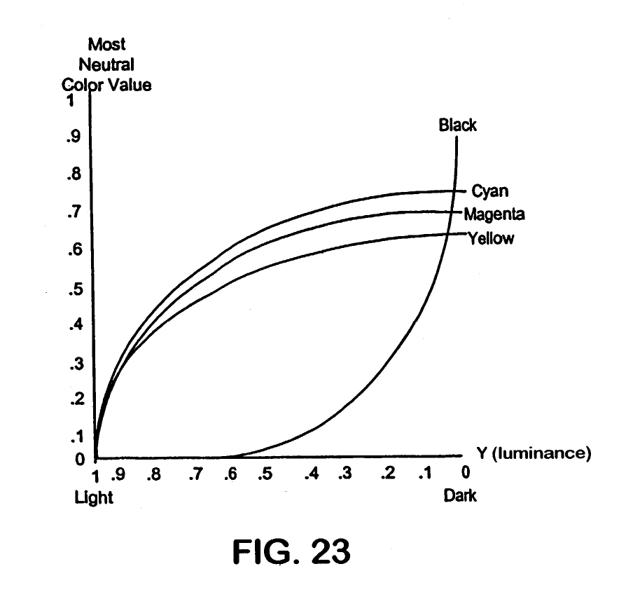

In a step 408, the ID creator unit 20 commands color printer 18 to output a set of target color patches of varying color amounts (i.e., coverage percentages) for each of its primary colors (typically C, M, Y and K). As is known, improved density and shading control may generally be achieved by printing using 6 color channels rather than 4 primary color channels. In particular, many “6-channel” printers are configured to print not only cyan, magenta, yellow, and black (CMYK), but also “light cyan” and “light magenta in order to provide such improved density and shading control. In accordance with one aspect of the invention, the 4-color CMYK density patches are adjusted in order to provide for improved dot gain control and otherwise superior performance when 6-channel color printers are employed. This adjustment may be made prior to printing of the above density patches, and involves using the color separation values of FIG. 19 and the light and dark color curves of FIG. 22 in order to determine the corresponding values of each of the 6 color channels based upon a given 4-channel CMYK value. As an example, FIGS. 19 and 23 indicate that the 50% Yellow density patch should instead be printed with approximately 45% Yellow ink if a 6-chanel printer is used. Similarly, the 40% Magenta target patch would be printed with 45% Light Magenta and 47% Magenta inks.

In the exemplary embodiment the coverage percentages of the color patches printed for each primary color ranges from 0% to 100% and recorded in a CMYK density (linearization) file. In a specific implementation a set of P color patches are printed for each primary color at the following coverage percentages: 0, 0.4, 0.8, 1.2, 2, 3, 4, 5, 10, 20, 30, 40, 50, 60, 70, 80, 90, and 100%. Accordingly, in this specific implementation a total of 72 color patches (4 primary colors and 18 target patches per color) will be printed by the color printer 18 in four rows having eighteen colors per row.

The spectra of each color patch is then measured by a spectrophotometer (not shown) at a predetermined number of wavelengths (step 416). In the exemplary embodiment the spectrophotometer measures the spectra of each color patch M times (e.g., 31) at wavelengths ranging between 400 nm-700 nm. Spectral measurements for 0% color (white) will typically result in floating point measurement values of approximately 1.0, while measurements of 100% coverage percentage will generally yield floating point values of approximately 0. The spectral measurements for each color patch at each of these M wavelengths are stored within memory of the ID creator unit 20.

The ID creator unit 20 then effectively increases the number of color patches spectrally measured by interpolating the spectral measurements associated with the N color patches actually physically measured by the spectrophotometer (step 420). To this end, the ID creator unit 20 defines a set of N′ (e.g., 256) color patch coverage percentages (i.e., color densities from 0 to 255) by interpolating among the coverage percentages of the N color patches actually measured by the spectrophotometer. In the exemplary embodiment this interpolation is effected by the ID creator unit 20 through use of a curve segment calculation routine based upon spline interpolation, such as is described in Appendix C. These interpolated color patches range in coverage percentage range from 0% to 100%, and each is associated with a set of M spectral measurements (one at each of the wavelengths originally used by the spectrophotometer). This interpolation operation effectively simulates the spectral measurement by the spectrometer of a set of 256 color patches at M different wavelengths. The M spectral measurement values associated with each of the N′ interpolated color patches are stored within memory of the ID creator unit 20.

A number of the N′ interpolated color patches are then selected for further processing (step 422). The number selected will generally depend upon the processing power of the ID creator unit 20 (i.e., given unlimited processing power, all N′ interpolated color patches would be selected). In the exemplary embodiment a set of 14 interpolated color patches are selected, and the M spectral measurement values associated with each are stored within a temporary table within memory of the ID creator unit 20. Given unlimited processing capabilities, all 256 measurements would be used. However, it is currently envisioned that 14 measurements associated with the following percentages will be selected: 0, 3, 4, 5, 10, 20, 30, 40, 50, 60, 70, 80, 90, and 100. Even if the number of selected values is small enough to be directly measured using the spectrophotometer as a practical matter, it is expected that the use of the above calculated values rather than directly measured values may aid in mitigating the adverse effects of dot gain.

The selected color measurement values are then expanded into a temporary grid containing every possible CMYK combination of such values (step 424). These CMYK color combinations establish the colorant combinations defining a printer N⁴ color table (described below) contained within the printer ID profile 76. In the exemplary embodiment this grid is configured such that spectral values for each CMYK combination are determined at 31 distinct wavelengths. In particular, the spectral measurements at a specified wavelength that are associated with each colorant of a given CMYK combination are multiplied in order to yield the spectral value stored within the CMYK grid at the location corresponding to such combination and wavelength. For example, for the grid location associated with the CMYK combination of C(5%), M(0%), Y(10%), and K(10%) at a wavelength of 400 nm, the spectral measurements of each colorant percentage at 400 nm are multiplied together to achieve a single spectral value stored within the CMYK grid. This process is repeated 30 more times for every other wavelength value associated with the C(5%), M(0%), Y(10%), and K(10%) color combination. As a result, spectrum values are calculated for all wavelengths associated with all CMYK color combinations described above. In one embodiment this results in creation of a temporary version of the printer N⁴ color table comprised of a total of 38,416 color targets (14⁴), each defined by 31 wavelength measurements—which results in storage of a total of 1,190,896 separate spectral values within the table. In a lower-resolution embodiment a set of six coverage percentages are selected for the CMYK grid points, which results in a total of 1,296 color targets (6⁴). With each target being subjected to 31 wavelength measurements, a total of 40,176 separate wavelength values are recorded. These 6 percentage values will represent the 6 CMYK grid points.

The spectral values stored within the temporary version of the N⁴ color table are then converted into XYZ data for each CMYK colorant combination by the ID creator unit 20 using known conversion formulas (step 428). See, e.g., the known CMYK/XYZ transformation curves developed by Gunter Wyszecki and W. S. Stiles set forth in Appendix C. The resultant XYZ color data is then transformed to L*a*b* curve data using known conversion formulas such as, for example, the transformations of Wyszecki and Stiles set forth in Appendix C (step 432). Next, the L*a*b* curve data is converted into an HCL curve in accordance with known transformation formulas described in Appendix C (step 436). As is described below, the HCL curve is stored within the inventive printer ID profile 76 in order to facilitate manual correction of hue, saturation, and lightness. The L*a*b* curve values derived above are also mapped to the CMYK grid coordinates of the printer N⁴ color table, which functions as a look-up table when stored within the printer ID profile 76 (step 438). In the exemplary embodiment the printer N⁴ color table is loaded into the space of the printer ID profile 76 associated with tag A2B1.

### L*a*b* to CMYK Color Space Transformation

As mentioned above, FIGS. 5-7 describe the process 308 for generating L*a*b* to CMYK color space transformation information for incorporation within the printer ID profile 76. Referring now to FIG. 5, a flowchart is provided of an exemplary approach to generating a L*a*b* grid and dot gain compensation information pertinent to creation of the L*a*b* to CMYK color space transformation table incorporated within the printer ID profile 76. As an initial step, a L*a*b* grid is established in a predetermined number of steps (e.g., 33) using normalized L*a*b* values from 0 to 1 (step 504). Specifically, the first point of the L*a*b* grid may be denoted by {L0 a0 b0}, the next Lab grid reference will be {L0 a0 b1/33}, and so on up to and including {L0 a0 b1 (33/33)}. This cycle continues with the grid points {L0 a1/33 b0} through {L0 a1/33 b1}, and then with {L0 a2/33 b0} through {L0 a2/33 b1}, and terminates upon establishing the L*a*b* grid point {L1 a1 b1}. This process may be express using pseudo code as follows:

For L1=0 to 1 step 1/33

For a1=0 to 1 step 1/33

For b1=0 to 1 step 1/33

L=L1, a=a1, b=b1

Establish Lab grid

{33 grid points}

{Step by 1/33 until 33/33}

In an exemplary implementation each step coefficient of 1/33 is multiplied by the factor 65535 in order to yield a 16-bit number, which is consistent with the requirements of the ICC specification to utilize only 8-bit or 16 bit tables.

Dot Gain Compensation

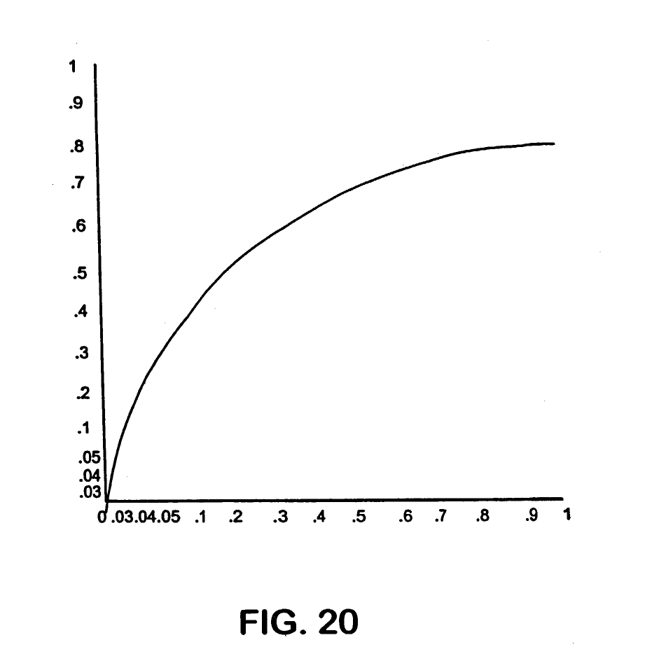

In order to compensate for the effects of dot gain, a dot gain compensation curve (FIG. 20) is generated using the ID creator unit 20 as follows. First, the above-described spectrophotometer color patch measurements are recalled and a most light absorbing wavelength (MLA) is determined for all color percentage values greater than 0% and less than 100% (step 508). In particular, the absorption of the white point (0% colorant) for each of the four CMYK colors is measured at a predetermined wavelength and established as a baseline for comparison purposes. Next, the absorption of a given colorant at a given percentage is measured and recorded at each of the above-referenced 31 wavelength values (between 400 nm-700 nm). The wavelength for which the measured absorption differs by the greatest amount from the white point absorption corresponds to the MLA for the given colorant percentage. This process is repeated for each of the above-referenced 12 colorant percentages between 0% and 100% for each colorant of the four CMYK colorants. Accordingly, in the exemplary embodiment a set of 12 MLA wavelengths will be identified for each CMYK color corresponding to the color patch percentages between 0%-100%.

Using the MLA wavelengths associated with each color percentage of each of the four CMYK colorants, a dot gain curve is generated by interpolation using the ID creator unit 20 for each such colorant (step 512). As an initial step in plotting of the dot gain curve for each color, the ID creator unit 20 first determines a Y-axis factor for each color percentage (P) of a given colorant using the following relationships:

Index=MLA wavelength

Rp=X[index]/W[index] {X=The measured floating point value of P. W=White (0%)}

Rc=C[index]/W[index] {C=The measured floating point value of the color at 100%}

Y=(1−Rp)/(1−Rc)

As an example, consider determination of the Y-axis factor for the Cyan colorant at 50% colorant density under the conditions that its MLA wavelength was is determined to be 550 nm and X=0.4. If it is also assumed that the absorption of 0% Cyan (white) at 550 nm is measured to be 0.95 and the absorption of 1000% Cyan at 550 nm is measured to be 0.05, then the Y-axis factor is determined as follows:

Rp=0.4/0.95=0.421

Rc=0.05/0.95=0.053

Y=(1−0.421)/(1−0.053)=0.611

Once the Y-axis factors at each of the 12 colorant percentages for each CMYK colorant, such factors form a set of data points from which the dot gain curves for each colorant may be generated using known interpolative techniques. See, for example, the exemplary curve segment calculations based upon spline interpolation which are set forth in Appendix C.

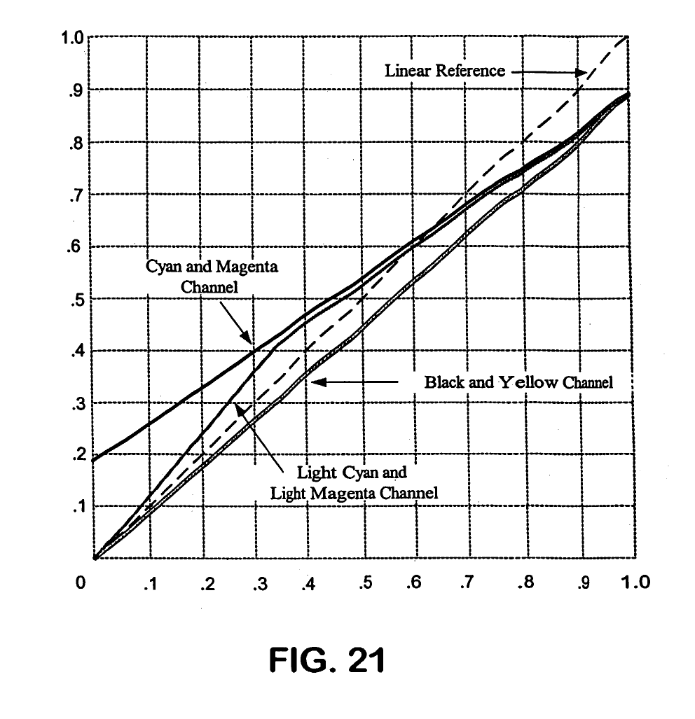

Referring again to FIG. 5, in a step 520 a 6-channel transfer curve is generated and stored within the printer ID profile 76. Specifically, the 4-channel dot gain curve may be inversed and split into a 6-channel representation using the color separation values set forth in FIG. 19. The values of the resultant 6-channel inversed dot gain curve (i.e., the “base curve”) are then combined with corresponding values of a mixing curve (Table I and FIG. 21) in accordance with the expression: (Y_{MIXING}/X_{MIXING})*(Y_{BASE}). The resultant 6-channel curve, termed the “transfer curve”, is saved within the printer ID profile 76 at a predefined location (e.g., at the tag “!TRN”).

TABLE I

| Color | X | Y |
|---|---|---|
| Cyan | 0 | 0 |
| | 0.19215686 | 0 |
| | 1 | 0.88235294 |
| Magenta | 0 | 0 |
| | 0.19215686 | 0 |
| | 1 | 0.88235294 |
| Yellow | 0 | 0 |
| | 1 | 0.88235294 |
| Black | 0 | 0 |
| | 1 | 0.88235294 |
| Light Cyan | 0 | 0 |
| | 0.34901961 | 0.41568627 |
| | 1 | 0.88235294 |
| Light Magenta | 0 | 0 |
| | 0.34901961 | 0.41568627 |
| | 1 | 0.88235294 |

The following examples illustrate the manner in which a transfer curve may be generated in accordance with the present invention:

1. Assume that the dot gain curve plotted for Cyan results in Y=0.7 when X=0.5. When the curve is inversed, Y=0.3 when X=0.5. The Cyan curve is then split into two colors based upon the color channel separation values. An “unsplit” value of 0.3 results in a Light Cyan value of 0.57 and a Cyan value of 0.08. These values represent the “Base Curve” Y values. In this example the X value remains constant at 0.5 with respect to the Y value of each split channel. Using the mixing curve representation of FIG. 21, it is determined that the Light Cyan Y value is approximately 0.52 when X equals 0.5. For Cyan's dark channel, Y value of the mixing curve of FIG. 21 is approximately 0.53 when X equals 0.5. In the case of Light Cyan, employing the above-referenced expression, (Y_{MIXING}/X_{MIXING})*(Y_{BASE}), to the present example (i.e., (0.52/0.5)*0.57), yields a combined Y value of 0.5928. Employing this same expression to the Cyan Dark Channel (i.e., (0.53/0.5)*0.08) results in a combined Y value of 0.0848. Accordingly, if a transfer curve were constructed based upon the above exemplary values, then under the condition of X=0.5 the Y-axis value of the Light Cyan channel is 0.5928 and the Y-axis value of the Cyan channel would be 0.0848.

2. Assume that the dot gain curve plotted for Yellow results in the same values as in the previous example (i.e., X=0.5, Y=0.7). This would result in the same inversed values as in the previous example (i.e., X=0.5, Y=0.3); however, since yellow is not split into light and dark ink channels, these values would also correspond to the values of the Base Curve for Yellow. Using the mixing curve graph of FIG. 21, it is determined that the Yellow Y-axis value is approximately 0.45 when X is 0.5. Employing the above-referenced combining formula for Yellow (i.e., (0.45/0.5)*0.3) results in an combined Y value of 0.27. Accordingly, a transfer curve constructed based upon the values of the present example would register a Y-axis value for the Yellow channel of 0.27 under the condition of X=0.5.

Gray Balance Modification

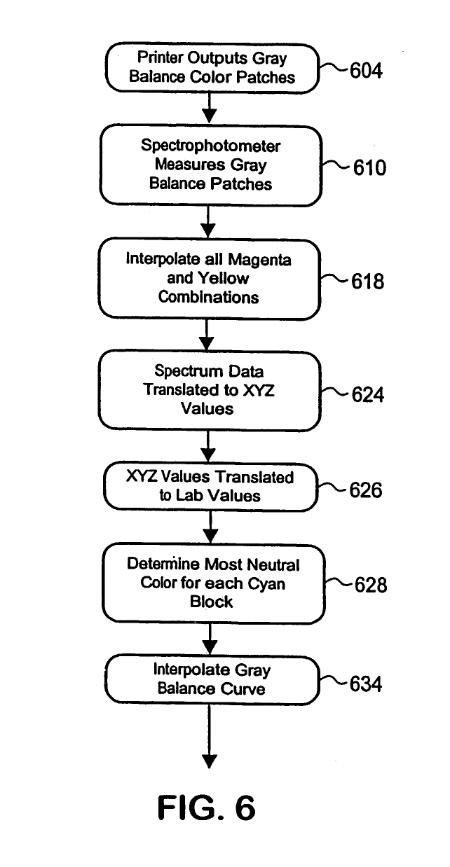

FIG. 6 is a flowchart representative of a gray balance modification process pertinent to generation of the L*a*b* to CMYK color space transformation incorporated within the printer ID profile 76. Turning to FIG. 6, in a step 604 the ID creator unit 20 causes printer 18 to print four set of blocks of 25 gray balance color patches. An exemplary set of CMY percentages for each such gray balance patch are presented in Appendix A. In accordance with the invention, the CMY percentages set forth in Appendix A are derived using the 6-channel transfer curve generated above so as to appropriately account for dot gain. In the exemplary embodiment Cyan is used as the control color, so that the first of the four blocks of gray balance patches each contain 25% Cyan. Similarly, the second block of patches contains 50% Cyan, the third block includes 75% Cyan, and the fourth block has 85% Cyan.

The ID creator unit 20 then commands a spectrophototmeter to measure the spectrum of each gray balance patch at each of 31 wavelengths between 400 nm-700 nm (step 610). For each gray balance patch, the resulting 31 spectra and associated wavelength values are stored along with the applicable CMY percentages of the patch are stored within the ID creator unit 20. Next, in a step 618 the ID creator unit 20 employs a curve segment calculation using spline interpolation in order to determine the spectral values associated with a set of interpolated gray balance patch values for which spectral values were not directly measured in step 610. In the exemplary embodiment these interpolated gray balance patch values include every whole percentage combination of Magenta and Yellow within the range of the applicable Cyan control block. For example, for the “25% Cyan” control block, the ID creator unit 20 will use interpolation to determine spectral values associated with all whole number percentage combinations of Magenta and Yellow between 10%-30%. Using known conversion formulas (Appendix C), the ID creator unit 20 converts convert the 31 spectrum values associated with interpolated gray balance patch color into XYZ data (step 624). The resulting XYZ data is then converted into L*a*b* color data using know formulas (Appendix C) and stored within a temporary table along with the associated Y (luminance) value (step 626).

Once the temporary table of L*a*b* values has been generated, the ID creator unit 20 analyzes the L*a*b* values associated with every Magenta/Yellow percentage combination of each Cyan control block in order to determine the most neutral color within each control block (step 628). Specifically, the ID creator unit 20 deems the color having the smallest “ab” vector (i.e., the smallest square root of a²b²) to be the most neutral within the applicable Cyan control block. The ID creator unit 20 stores the Cyan control percentage, the Magenta and Yellow interpolated percentages, and the Y (luminance) value (floating point number between 0 and 1) for each of the four colors determined to be most neutral (i.e., the most neutral color for each of the four Cyan control blocks).

Using these four most neutral colors, a 4-channel gray balance curve of the type depicted in FIG. 23 is generated by interpolation (step 634). Specifically, the colorant percentage values for these four most neutral colors are normalized to values between 0 and 1. The values of the color components of each neutral color are separated and are defined by the 4-channel gray balance curve (FIG. 23), while the X-axis represents the Y (luminance) value associated with each color component value. In this way a set of 3 separate gray balance curves associated with the three color channels Cyan, Magenta, and Yellow are plotted as function of Y (luminance), which in the exemplary embodiment proceeds from 1 (light) to 0 (dark) along the X-axis.

In the exemplary embodiment, a K-channel gray balance derived from the color engineering experience of the inventors is also provided and is depicted in FIG. 23. The K-channel gray balance curve serves to minimize the influence of the black ink, and to determine final Y-axis values for each color channel (Cyan, Magenta, Yellow) under the condition that Y (luminance) is equal to 0. This determination of color channel end point values is further described in the portion of Appendix C relating to color end point calculation. Introduction of the K-channel has the affect of lowering the values of the remaining CMY color channels as a luminance value of 0 is approached along the X-axis, since less color is used in order to account for the presence of black ink. The curve of FIG. 23 associated with each color channel may be constructed through spline interpolation by (1) generating a first segment from the origin to the first plotted XY coordinate, (2) a plurality of segments between the plotted XY coordinates, and (3) a final segment from the last XY coordinate to the predicted color end point based on the K channel.

Color Correction

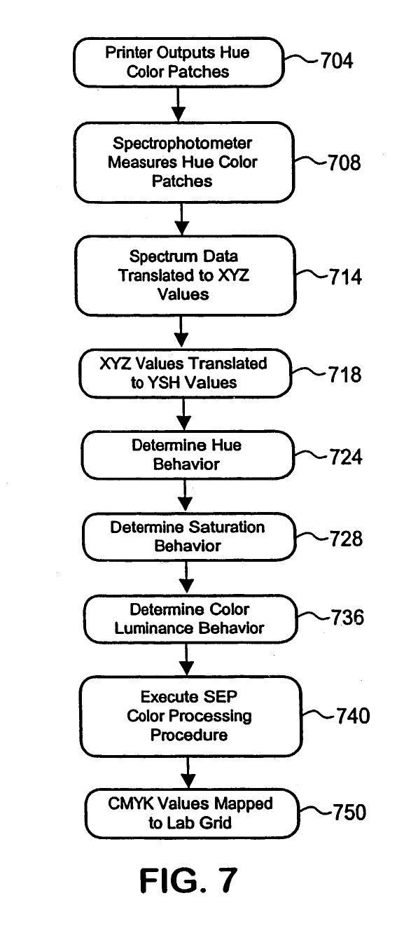

FIG. 7 is a flowchart representative of a color correction process performed during generation of the L*a*b* to CMYK color space transformation incorporated within the printer ID profile 76. Referring now to FIG. 7, in a step 704 the ID creator unit 20 causes printer 18 to print a set of 180 CMY hue color patches using the colorant percentages set forth in the hue target table of Appendix B. In the exemplary embodiment, the hue color patches are produced using the 6-channel transfer curve derived above so as to account for dot gain. The spectra of the set of 180 hue target colors are then measured by the spectrophotometer at each of 31 wavelengths between 400 nm-700 nm (step 708). The resultant spectral measurements are then stored by the ID creator unit 20 along with the associated CMY hue percentages. The ID creator unit 20 then converts the spectral measurements into XYZ color data using, for example, the publicly available conversion formulas set forth in Appendix C (step 714). Next, this XYZ color data is transformed into measured YSH data using other known formulas set forth in Appendix C (step 718).

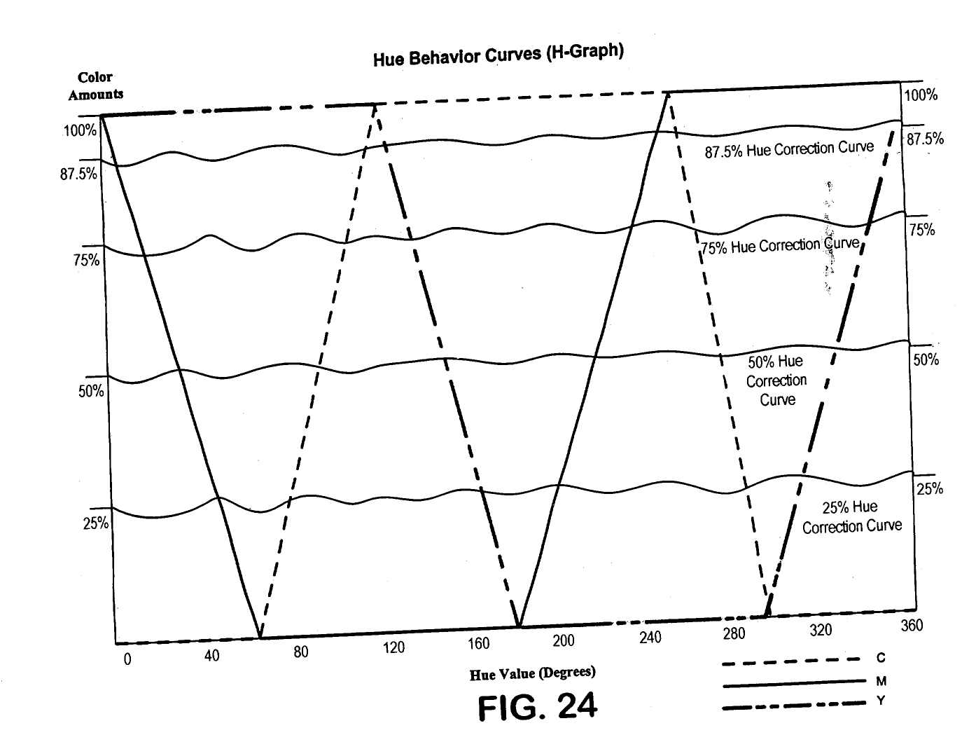

The ID creator unit 20 then operates to determine hue behavior by graphing the H (hue) values of this measured YSH data relative to dot percentage amount in order to yield hue behavior curves of the type set forth in the exemplary H-Graph representation of FIG. 24 (step 724). Specifically, the block of 36 target colors within the hue target table of Appendix B which include a C, M, or Y component having a dot coverage of 100% are used to generate the 100% hue correction curve (i.e., the colors within the two columns at the far right of the hue target table of Appendix B). That is, the hue (H) of the measured YSH data for each of these target colors is determined from the associated measured YSH data and plotted as a function of dot percentage (preferable expressed as a range of 0 to 360 degrees rather than the normalized range of 0 to 1). The remaining 144 target YSH values comprise four other blocks of 36 target colors, and are similarly used to calculate the hue correction curves at 87.5%, 75%, 50%, and 25%. For example, the 87.5% correction curves are generated based upon the colors within the hue target table of Appendix B containing a maximum dot coverage percentage of 87.5% (i.e., the colors within the third and fourth columns from the right in such hue target table). If the color printer 18 were operative to produce patches having perfect hue amounts, the associated measured YSH data would be such that the resulting “correction curves” would be straight lines. However, in practical implementations of the printer 18 it is common for ink impurities and mechanical imperfections for non-linear measurement results to be obtained. This tends to result in hue correction curves which “wave” about the applicable percentages in the manner illustrated by the H-Graph of FIG. 24.

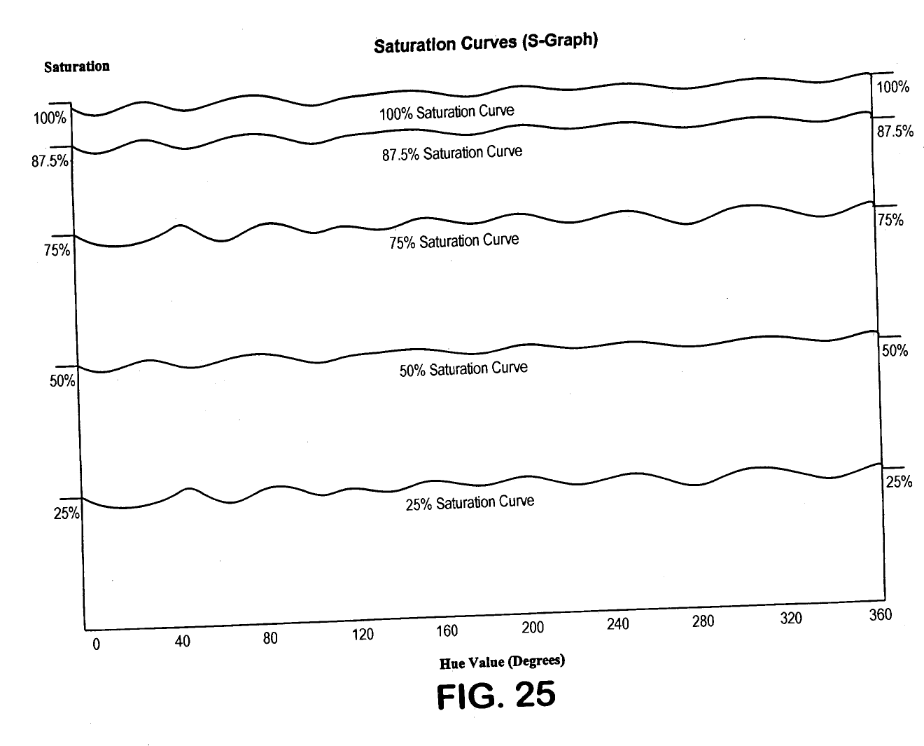

Turning now to FIG. 25, there is shown an exemplary S-Graph generated by the ID creator unit 20 that is indicative of saturation behavior of the color printer 18. The ID creator unit 20 determines the saturation behavior illustrated by FIG. 25 by graphing the values of H (hue) relative to S (saturation) using the measured YSH data (step 728). Each of the above-described five blocks of 36 target saturation values are graphed against the same circular H values at 100%, 87.5%, 75%, 50%, and 25% levels of saturation. Again, if the printer 18 were capable of producing images having perfect saturation, the resultant saturation behavior graphs produced by the ID creator unit 20 would comprise a set of straight lines. However, imperfections associated with practical implementations of the printer 18 result in measured saturation values may be greater than, less than, or equal to predicted saturation values for each applicable hue value.

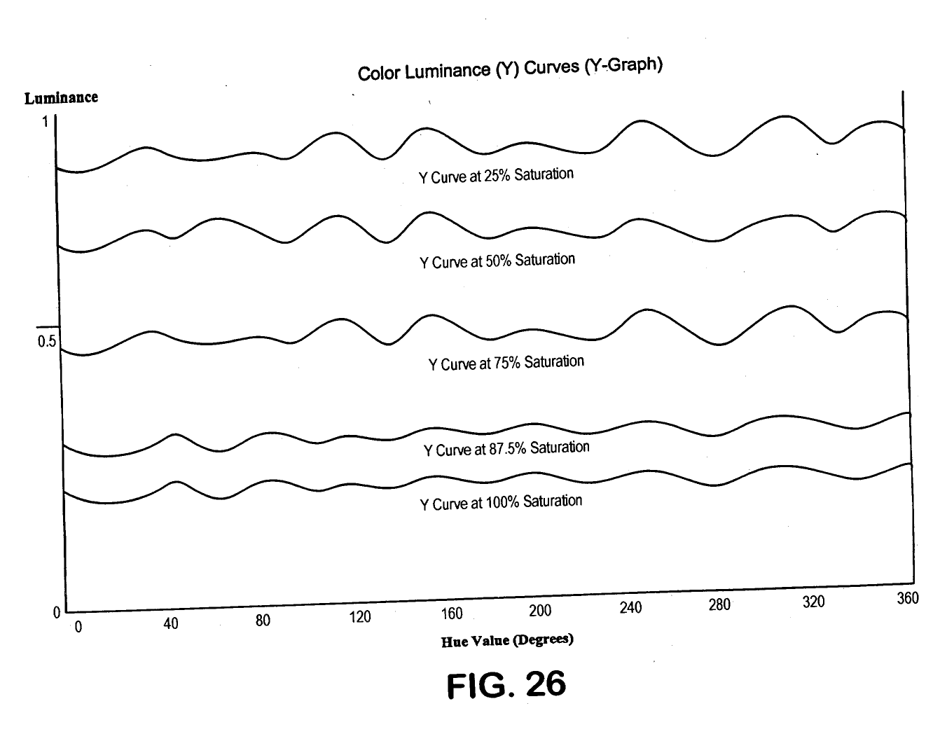

FIG. 26 shown an exemplary Y-Graph generated by the ID creator unit 20 that is indicative of luminance behavior of the color printer 18. The ID creator unit 20 produces the Y-Graph of FIG. 26 by graphing H (hue) values against Y (luminance) using the saturation levels of the measured YSH data (step 736). The Y values are plotted on the Y-axis of FIG. 26 and range from 0 (dark) to 1 (light). Each of the above-described five blocks of 36 measured target Y values are graphed against the same circular H values at the 25%, 50%, 75%, 87.5%, and 100% dot coverage percentages.

Referring again to FIG. 7, the ID creator unit 20 executes a SEP color processing procedure using the above-described gray balance curves, the Y-Graph, the S-Graph and the H-Graph in order to transform the measured YSH data into CMYK data (step 740). As is described below, the SEP procedure contemplates transforming the measured YSH data into CMYK data through manipulation of the SEP parameters Hue, Amount and Gray.

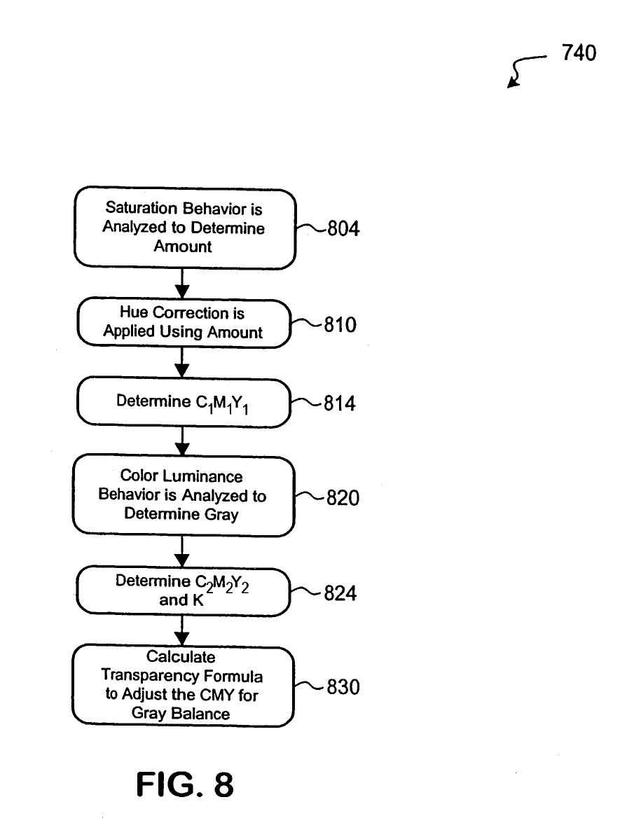

Turning now to FIG. 8, a flowchart is provided which illustratively represents the SEP color processing procedure. As an initial step in the SEP procedure, saturation behavior is analyzed in order to the Amount parameter (step 804). Specifically, the five measured saturation curves from the above-described S-Graph (i.e., the curves corresponding to saturation levels of 100%, 87.5%, 75%, 50%, 25%) are used to derive a set of non-measured saturation curves for all other whole-number percentage values between 1%-99%. This derivation may be effected using known interpolation techniques such as, for example, spline interpolation. For each measured YSH color value, a corresponding Amount value is determined by reading the saturation curve associated with the same saturation (S) as the YSH color value, with the curve being read at the Hue value (H) of such YSH color value. For example, assuming a YSH color value having a saturation of 48% (i.e., S=48%) and a hue of 40% (i.e., H=40°), the value of the non-measured 48% saturation curve at 40° would be used for the Amount. For purposes of the present example, it is assumed that this Amount value is equivalent to 47%.

The SEP process continues by application of a hue correction value based upon the Amount quantity obtained above (step 810). In particular, the four non-linear measured hue correction curves included within the above-described H-Graph (i.e., the curves corresponding to saturation levels of 100%, 87.5%, 75%, 50%, 25%) are used to derive a set of non-measured hue correction curves for all other whole-number percentage values between 1%-99%. This derivation may be effected using known interpolation techniques such as, for example, spline interpolation. For each measured YSH color value, a new Hue value is determined by shifting the original Hue value of such color value by the difference between one of such non-linear hue correction curves and a corresponding linear hue correction curve. The non-linear hue correction curve to be used is the one of the measured or interpolated hue correction curves associated with the same coverage percentage as the Amount value obtained above. Accordingly, to extend the above example the 47% non-linear hue correction curve is selected (since in the above example Amount was determined to be equal to 47%) and read at a Hue value of 40° in order to determine a hue correction value. If it is assumed for exemplary purposes that this hue correction value is 49% (i.e., +2% from a linear value of 47%). The difference between these correction values (i.e., 47-49) yields a −2° hue shift value, which when applied to the original H Hue value shifts it to 38°.

Next, the curve of the H-Graph corresponding to a saturation level of 100% is used to determine initial Cyan (C₁), Magenta (M₁), and Yellow (Y₁) values at the shifted original Hue value (step 814). Continuing with the present example, using a Hue at 38° results in a C₁ of 0%, an M₁ of 39%, and a Y₁ of 100%.

The SEP process is continued by analyzing luminance behavior in order to determine the Gray parameter (step 820). In particular, the five non-linear measured luminance correction curves included within the above-described Y-Graph (i.e., the curves corresponding to saturation levels of 100%, 87.5%, 75%, 50%, 25%) are used to derive a set of non-measured luminance correction curves for all other whole-number percentage values between 1%-99%. This derivation may be effected using known interpolation techniques such as, for example, spline interpolation. For each measured YSH color value, determine a YA value by selecting the one of the curves of the Y-Graph associated with the Amount percentage at the original Hue value. The corresponding Gray value may be determined as follows: Gray=Y+(1−Y_{Δ}). Continuing with the present example, Y_{Δ} is the Y-axis value obtained using the curve on the Y-Graph corresponding to a saturation level of 47% (i.e., since Amount is 47%) at the 40° point (the original H value). Assuming for exemplary purposes that the value of Y in the measured YSH data is 0.5, then Y_{Δ}=of 0.78. It follows that the Gray value would be 0.72 (i.e., 0.5+(1-0.78)).

Using the G-Graph, gray balance values Cyan (C₂), Magenta (M₂), Yellow (Y₂) and Black (K) are determined on the basis of the Gray value obtained above (step 824). In particular, the gray balance C₂M₂Y₂K are determined from the G-Graph at the gray luminance (Y_{g}) level associated with the Gray value. In particular, the C curve of the G-Graph is used to obtain the value of C₂, the M curve of the G-Graph is used to obtain the value of M₂, the Y curve of the G-Graph is used to obtain the value of Y₂, and the K curve of the G-Graph is used to obtain the value of K. Continuing with the present example, using a Y_{g} of 0.72 (Gray) results in C₂=0.15, M₂=0.20, Y₂=0.22, and K=0.

The SEP process is concluded by determining final CMY adjustments based upon a transparency formula and generation of a 4-channel gradation curve (step 830). In the exemplary embodiment the transparency formula is given by Color₁+(Color2×(1−Color₁)), and is used to determine a set of final CMY adjustments. After translating the initial CMY percentage values to decimal equivalents, the transparency formula is applied in the present example as follows:

C=0+(0.15×(1−0))=0.15 (Cyan)

M=0.39+(0.20×(1−0.39))=0.532 (Magenta)

Y=1.00+(0.22×(1−1))=1.00 (Yellow)

Referring again to FIG. 7, in a step 750 the CMYK values obtained through the SEP process (FIG. 8) are mapped to the normalized L*a*b* grid coordinates created previously (step 750). The resultant CMYK-to-L*a*b* grid map is stored as a look up table and loaded into the printer ID profile 76 (e.g., at tag B2A1).

Synthesis of Printer ID Profile Using Color Space Transformation Information

Turning now to FIG. 9, the process 340 for synthesizing the printer ID profile 76 on the basis of the color space transformation information discussed above is described in greater detail. In the exemplary embodiment the format of the printer ID profile 76 will adhere to the requirements for a ColorSpace Conversion Profile set forth in the Specification File Format for Color Profiles promulgated by the International Color Consortium (ICC), which currently is defined by version ICC.1:2001-04 (the “Specification”).

The process of synthesizing the printer ID profile 76 is initiated by building a printer ID profile header (step 904). The Specification contemplates a set of 15 required fields, each of which is incorporated within the printer ID profile header and described below:

Profile Size: The total size of the printer ID profile 76 (in bytes) as calculated by the ID creator unit 20.

Color Management Model (CMM) Type Signature: A parameter required in connection with ColorSynch processing using a Heidelberg Druck Machine (“HDM”).

Profile Version: The Revision Number of the ICC Specification to which the printer ID profile adheres (currently “2.4.0”).

Profile/Device Class Signature: “ptr” (Output Device Profile)

Color Space Signature: “CMYK”

Profile Connection Space Signature: “L*a*b*”

Creation Date: The date/time value (generated by the ID creator unit 20) of the date of first creation of the printer ID profile 76. The date/time value is expressed in terms of year, month, day, hour, minute and second.

Profile File Signature: “ascp” (ICC required value {61637370h})

Primary Platform Signature: “APPL” (for Apple Computer, Inc.)

Profile Flags: “00” (Not embedded, Use anywhere)

Device Manufacturer and Model Signatures: Blank (None)

Attributes: “0000” (Reflective, Glossy, Positive, Color)

Rendering Intent: “0” (Perceptual)

White Point: The X, Y, Z values of the measured white patch.

Profile Creator Signature: Blank (None)

The CMYK-to-L*a*b* look up table derived above is stored within the printer ID profile 76 as the ICC Transformation Parameter Structure Tag A2B1 (lut16Type) (step 908). Similarly, the L*a*b*-to-CMYK look up table derived above is stored within the printer ID profile 76 as the ICC Transformation Parameter Structure Tag B2A1 (lut16Type) (step 912).

Synthesis of the printer ID profile 76 continues through storage of the 6-channel mixing curve derived above within an ICC private tag having the signature “MIXC” (step 918a). Similarly, the 6-channel transfer curve derived above is stored within an ICC private tag having the signature “!TRN” and incorporated within the printer ID profile 76 (step 918b). While both of these curves are stored via private tags and are thus unavailable to outside inspection, the data associated with these curves will be preferably be capable of being inspected and modified by way of the user interface provided by the ID creator unit 20.

Exemplary embodiments of the printer ID profile 76 will also incorporate the tags described below in Table II. The ID creator unit 20 calculates the size of each tag and will also apply all appropriate tag offsets (step 924).

TABLE II

| Tag | Signature | Description |
|---|---|---|
| CGX ID | CGX | Used to store private engineering data |
| | | relevant to the ID creator unit (i.e., not |
| | | available to the public). |
| Description | Desc | Stores a descriptive name for the printer |
| | | ID profile 76 (e.g., |
| | | “1280.CXD.3.7.02.icc”) |
| Copyright | Cprt | Copyright information |
| White Point | Wtpt | Measured White Point's XYZ values. |
| Mix Curve | MIXC | 6-channel mixing curve |
| Gray Curve | GRAC | 4-channel (CMYK) curve based on gray |
| | | targets |
| Gradation Curve | GRAD | 4-channel (CMYK) curve based on hue |
| | | targets and adjusted using the SEP color |
| | | process |
| HCL Curve | HCLC | 3-channel curve derived from L*a*b* |
| | | color space |
| Transfer Curve | !TRN | 6-channel curve derived from linearization |
| | | dot gain curve and mixing curve |
| CMYK-to-Lab | A2B1* | Color-corrected L*a*b* color space |
| CLUT | | mapped to a CMYK 6 step grid (see step |
| | | 908) |
| Lab-to-CMYK | B2A1* | Color corrected CMYK color space |
| CLUT | | mapped to L*a*b* 33 step grid (see step |
| | | 912) |
| Lab-to-CMYK | Bli | 3-channel Lab input curve that corre- |
| Input Curve | | sponds to the Lab values in the B2A1 tag |
| Lab-to-CMYK | Blo | 4-channel CMYK output curve that corre- |
| Output Curve | | sponds to the CMYK values in the B2A1 |
| | | tag |
| YSH Curve | Blh | 3-channel YSH curve produced from the |
| | | hue color targets during the Lab-to-CMYK |
| | | color correction process |
| Lab-to-CMYK | !BA1 | A backup of the B2A1 tag used to support |
| Backup | | non-destructive editing by the CGX ID |
| | | Creator. |

### Creation of Press ID Profile

By way of overview, the press ID profile 74 includes a CMYK to L*a*b* color space transformation table, a L*a*b* to CMYK color space transformation table, a set of transverse color curves stored in a private area of the press ID profile 74, and a profile header. In the exemplary embodiment the press ID profile 74 will also include a tag table and tagged element data to the extent required by the applicable specifications promulgated by the ICC (see, e.g., Specification ICC.1:2001-04).

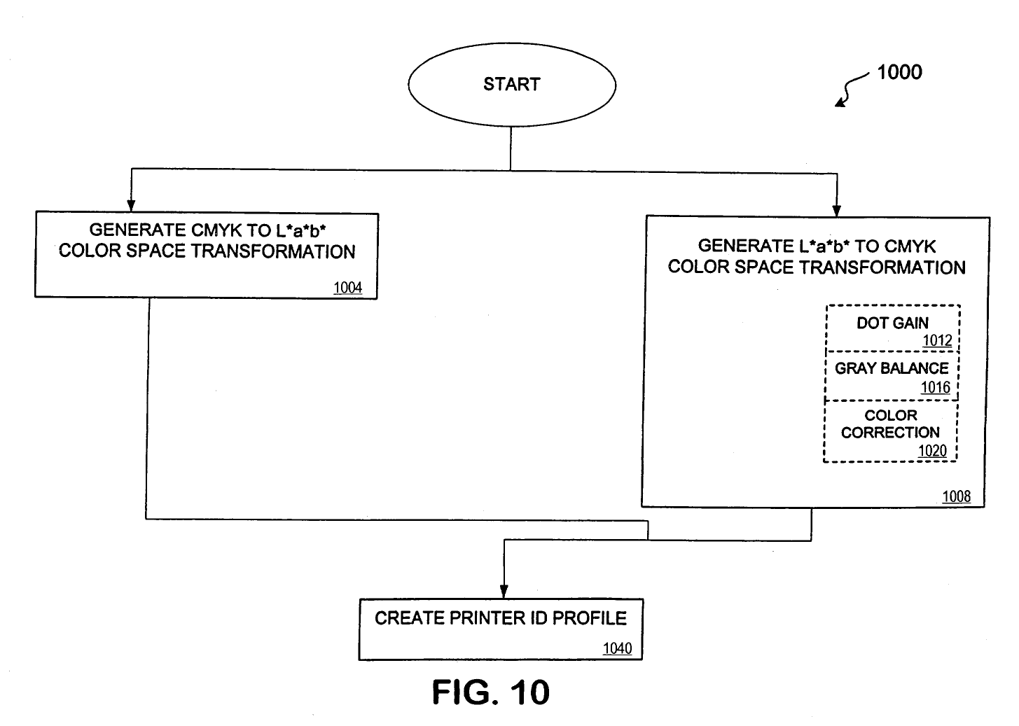

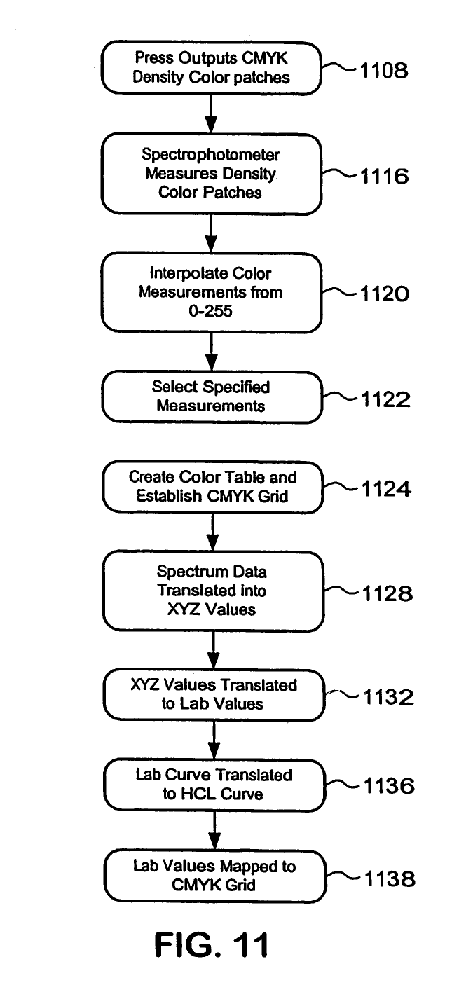

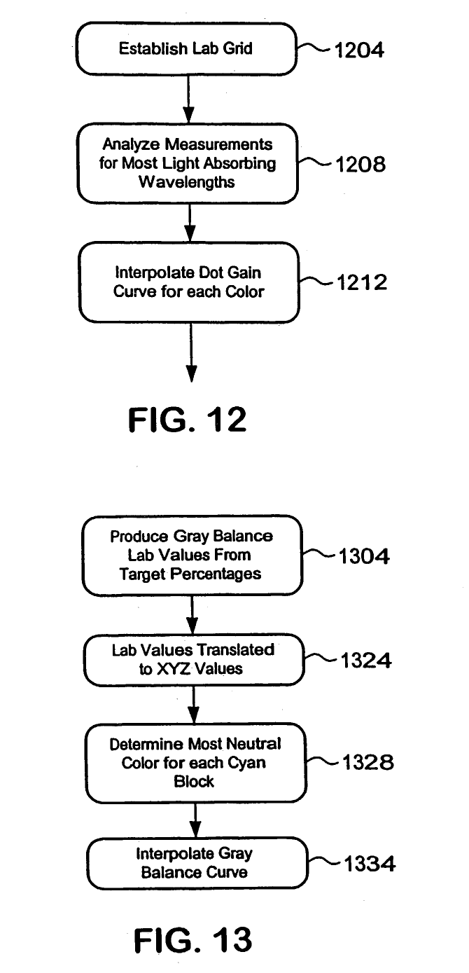

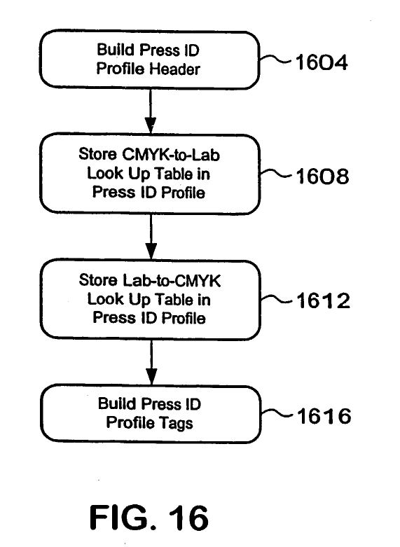

FIGS. 10-16 are flowcharts representative of an exemplary process for creating the press ID profile 74 in accordance with one aspect of the present invention. In particular, FIG. 10 illustratively depicts a high-level flowchart representative of an overall process 1000 of developing a press ID profile 74 in accordance with an exemplary embodiment of the invention. Each of the activities depicted in FIG. 10 are explained below with reference to FIGS. 11-16. Specifically, FIG. 11 describes generation of a CMYK to L*a*b* color space transformation table included within the press ID profile 74. Similarly, FIGS. 12-15 describe generation of a L*a*b* to CMYK color space transformation table included within the press ID profile 74. Finally, FIG. 16 describes the synthesis of the press ID profile 74 based upon the color space transformation information created during the processing described with reference to FIGS. 11-15.

Turning now to FIG. 10, the ID creator unit 20 generates certain CMYK to L*a*b* color space transformation information in connection with creation of the press ID profile 74 (step 1004). As is described below, the ID creator unit 20 also similarly creates L*a*b* to CMYK color space transformation information (step 1008). As part of this latter process, the ID creator unit 20 performs various operations such as dot gain compensation 1012, gray balance adjustment 1016 and color correction 1020. Finally, the color space transformation information generated during the preceding steps is incorporated within and otherwise utilized in synthesizing the press ID profile 74 (step 1040).

### CMYK to L*a*b* Color Space Transformation

FIG. 11 is a flowchart illustrating an exemplary process 1004 generating a CMYK to L*a*b* color space transformation information included within the press ID profile 74. In a step 1108, the printing press 22 outputs a set of target color patches of varying color amounts (i.e., coverage percentages) for each of its primary colors (typically C, M, Y and K). In the exemplary embodiment the coverage percentages of the color patches printed for each primary color ranges from 0% to 100% and recorded in a CMYK density (linearization) file. The number of patches is arbitrary but will preferably include a relatively greater number of samples at lighter color densities in order to obtain accurate spectrophotometer readings and perform accurate color calculations. In a specific implementation a set of P1 color patches are output for each primary color at the following coverage percentages: 0, 3, 4, 5, 10, 20, 30, 40, 50, 60, 70, 80, 90, and 100. Accordingly, in this specific implementation the printing press 22 will output a total of 56 color patches (4 primary colors and 14 target patches per color) will output by the press four rows having fourteen colors per row.

In addition to printing of the above target patches, the printing press 22 also outputs another 4×4 set of color correction targets of combined CMY colors. These 16 targets are used during a press L*a*b*-to-CMYK processing for color correction procedure (described below).

The spectra of each color patch (i.e., within both of the above sets of 16 and 56 target color patches) are then measured by a spectrophotometer (not shown) at a predetermined number of wavelengths (step 1116). In the exemplary embodiment the spectrophotometer measures the spectra of each color patch M1 times (e.g., 31) at wavelengths ranging between 400 nm-700 nm. Spectral measurements for 0% color (white) will typically result in floating point measurement values of approximately 1.0, while measurements of 100% coverage percentage will generally yield floating point values of approximately 0. The spectral measurements for each color patch at each of these M1 wavelengths are stored within memory of the ID creator unit 20.

The ID creator unit 20 then effectively increases the number of color patches spectrally measured by interpolating the spectral measurements associated with the N1 color patches actually physically measured by the spectrophotometer (step 1120). To this end, the ID creator unit 20 defines a set of N2 (e.g., 256) color patch coverage percentages (i.e., color densities from 0 to 255) by interpolating among the coverage percentages of the N1 color patches actually measured by the spectrophotometer. In the exemplary embodiment this interpolation is effected by the ID creator unit 20 through use of a curve segment calculation routine based upon spline interpolation, such as is described in Appendix C. These interpolated color patches range n coverage percentage range from 0% to 100%, and each is associated with a set of M1 spectral measurements (one at each of the wavelengths originally used by the spectrophotometer). This interpolation operation effectively simulates the spectral measurement by the spectrometer of a set of 256 color patches at M1 different wavelengths. The M1 spectral measurement values associated with each of the N2 interpolated color patches are stored within memory of the ID creator unit 20.

A number of the N2 interpolated color patches are then selected for further processing (step 1122). The number selected will generally depend upon the processing power of the ID creator unit 20 (i.e., given unlimited processing power, all N2 interpolated color patches would be selected). In the exemplary embodiment a set of 14 interpolated color patches are selected, and the M spectral measurement values associated with each are stored within a temporary table within memory of the ID creator unit 20. Given unlimited processing capabilities, all 256 measurements would be used. However, it is currently envisioned that 14 measurements associated with the following percentages will be selected: 0, 3, 4, 5, 10, 20, 30, 40, 50, 60, 70, 80, 90, and 100. Even if the number of selected values is small enough to be directly measured using the spectrophotometer as a practical matter, it is expected that the use of the above calculated values rather than directly measured values may aid in mitigating the adverse effects of dot gain.

The selected color measurement values are then expanded into a temporary grid containing every possible CMYK combination of such values (step 1124). These CMYK color combinations establish the colorant combinations defining a press N⁴ color table (described below) contained within the press ID profile 74. In the exemplary embodiment this grid is configured such that spectral values for each CMYK combination are determined at 31 distinct wavelengths. In particular, the spectral measurements at a specified wavelength that are associated with each colorant of a given CMYK combination are multiplied in order to yield the spectral value stored within the CMYK grid at the location corresponding to such combination and wavelength. For example, for the grid location associated with the CMYK combination of C(5%), M(0%), Y(10%), and K(10%) at a wavelength of 400 nm, the spectral measurements of each colorant percentage at 400 nm are multiplied together to achieve a single spectral value stored within the CMYK grid. This process is repeated 30 more times for every other wavelength value associated with the C(5%), M(0%), Y(10%), and K(10%) color combination. As a result, spectrum values are calculated for all wavelengths associated with all CMYK color combinations described above. Since in the exemplary embodiment a primary use of the CMYK-to-L*a*b* color space transformation information contained within the press ID profile 74 may be in connection with proofing, the press N⁴ color table may be created with a relatively high resolution of approximately “13”. That is, the press N⁴ color table may be generated so as to be comprised of a total of 28,561 color targets (13⁴), each defined by 31 wavelength measurements—which results in storage of a total of 885,391 separate spectral values within the table.

The spectral values stored within the temporary grid for the N⁴ color table are then converted into XYZ data for each CMYK colorant combination by the ID creator unit 20 using known conversion formulas (step 1128). See, e.g., the known CMYK/XYZ transformation curves developed by Gunter Wyszecki and W. S. Stiles set forth in Appendix C. The resultant XYZ color data is then transformed to L*a*b* curve data using known conversion formulas such as, for example, the transformations of Wyszecki and Stiles set forth in Appendix C (step 1132). Next, the L*a*b* curve data is converted into an HCL curve in accordance with known transformation formulas described in Appendix C and stored within the press ID profile 74 (step 1136). The L*a*b* curve values derived above are also mapped to the CMYK grid coordinates of the press N⁴ color table, which functions as a look-up table when stored within the press ID profile 74 (step 1138). In the exemplary embodiment the press N⁴ color table is loaded into the space of the press ID profile 74 associated with tag A2B1.

### L*a*b* to CMYK Color Space Transformation

As mentioned above, FIGS. 12-14 describe an exemplary process 1008 for generating L*a*b* to CMYK color space transformation for incorporation within the press ID profile 74. Referring now to FIG. 12, a flowchart is provided of an exemplary approach to generating a L*a*b* grid and dot gain compensation information pertinent to creation of the L*a*b* to CMYK color space transformation table incorporated within the press ID profile 74. As an initial step, a L*a*b* grid is established in a predetermined number of steps (e.g., 33) using normalized L*a*b* values from 0 to 1 (step 1204). Specifically, the first point of the L*a*b* grid may be denoted by {L0 a0 b0}, the next Lab grid reference will be {L0 a0 b1/33}, and so on up to and including {L0 a0 b1 (33/33)}. This cycle continues with the grid points {L0 a1/33 b0} through {L0 a1/33 b1}, and then with {L0 a2/33 b0} through {L0 a2/33 b1}, and terminates upon establishing the L*a*b* grid point {L1 a1 b1}. This process may be expressed using pseudo code as follows:

For L1=0 to 1 step 1/33

For a1=0 to 1 step 1/33

For b1=0 to 1 step 1/33

L=L1, a=a1, b=b1

Establish Lab grid

{33 grid points}

{Step by 1/33 until 33/33}

In an exemplary implementation each step coefficient of 1/33 is multiplied by the factor 65535 in order to yield a 16-bit number, which is consistent with the requirements of the ICC specification to utilize only 8-bit or 16 bit tables.

Dot Gain Compensation

As is described below, the dot gain compensation process used in generation of the press ID profile 74 utilizes uses the spectrophotometer measurements of the set of 56 color patch measurements which were made during creation of the press CMYK-to-L*a*b* color space transformation information described above. In accordance with the invention, the inverse of the calculated dot gain will be used to adjust the CMYK values ultimately stored within the applicable output tag (B2A1) of the printer ID profile 74.

In order to compensate for the effects of dot gain, a dot gain compensation curve is generated using the ID creator unit 20 as follows. First, the above-described spectrophotometer color patch measurements are recalled and a most light absorbing wavelength (MLA) is determined for all color percentage values greater than 0% and less than 100% (step 1208). In particular, the absorption of the white point (0% colorant) for each of the four CMYK colors is measured at a predetermined wavelength and established as a baseline for comparison purposes. Next, the absorption of a given colorant at a given percentage is measured and recorded at each of the above-referenced 31 wavelength values (between 400 nm-700 nm). The wavelength for which the measured absorption differs by the greatest amount from the white point absorption corresponds to the MLA for the given colorant percentage. This process is repeated for each of the above-referenced 12 colorant percentages between 0% and 100% for each colorant of the four CMYK colorants. Accordingly, in the exemplary embodiment a set of 12 MLA wavelengths will be identified for each CMYK color corresponding to the color patch percentages between 0%-100%.

Using the MLA wavelengths associated with each color percentage of each of the four CMYK colorants, a dot gain curve is generated by interpolation using the ID creator unit 20 for each such colorant (step 1212). As an initial step in plotting of the dot gain curve for each color, the ID creator unit 20 first determines a Y-axis factor for each color percentage (P) of a given colorant using the following relationships:

Index=MLA wavelength

Rp=X[index] W[index] {X=The measured floating point value of P. W=White (0%)}

Rc=C[index]/W[index] {C=The measured floating point value of the color at 100%}

Y=(1−Rp)/(1−Rc)

As an example, consider determination of the Y-axis factor for the Cyan colorant at 50% colorant density under the conditions that its MLA wavelength was is determined to be 550 nm and X=0.4. If it is also assumed that the absorption of 0% Cyan (white) at 550 nm is measured to be 0.95 the absorption of 1000% Cyan at 550 nm is measured to be 0.05, then the Y-axis factor is determined as follows:

Rp=0.4/0.95=0.421

Rc=0.05/0.95=0.053

Y=(1−0.421)/(1−0.053)=0.611

Once the Y-axis factors at each of the 12 colorant percentages for each CMYK colorant, such factors form a set of data points from which the dot gain curves for each colorant may be generated using known interpolative techniques (see, for example, the exemplary curve segment calculations based upon spline interpolation which are set forth in Appendix C). An exemplary dot gain compensation curve for a single color is set forth in FIG. 20.

Gray Balance Modification

FIG. 13 is a flowchart representative of a gray balance modification process pertinent to generation of the L*a*b* to CMYK color space transformation incorporated within the press ID profile 74. Turning to FIG. 13, in a step 1304 a set of gray balance curves are determined by the ID creator unit 20 using the gray target CMY percentages set forth in Appendix A and a CMYK-to-L*a*b* look up table (described below) generated for the applicable printing press 22. In particular, the entries within the CMYK-to-L*a*b* look up table corresponding to the gray target CMY percentages of Appendix A are retrieved. The ID creator unit 20 then creates a temporary table by storing these retrieved L*a*b* values as a function of the gray target CMY percentages (normalized into CMYK grid values). The L*a*b* values within the temporary table are then converted into XYZ color data using the known transformations set forth in Appendix C (step 1324). In addition, the luminance or “Y” value of each CMYK grid value is stored in association with the L*a*b* value associated with such grid value.

Once the temporary table of L*a*b* values has been generated, the ID creator unit 20 analyzes the L*a*b* values associated with every Magenta/Yellow percentage combination of each Cyan control block in order to determine the most neutral color within each control block (step 1328). Specifically, the ID creator unit 20 deems the color having the smallest “ab” vector (i.e., the smallest square root of a²b²) to be the most neutral within the applicable Cyan control block. The ID creator unit 20 stores the Cyan control percentage, the Magenta and Yellow interpolated percentages, and the Y (luminance) value (floating point number between 0 and 1) for each of the four colors determined to be most neutral (i.e., the most neutral color for each of the four Cyan control blocks).

Using these four most neutral colors, a 4-channel gray balance curve of the type depicted in FIG. 23 is generated by interpolation (step 1334). Specifically, the colorant percentage values for these four most neutral colors are normalized to values between 0 and 1. The values of the color components of each neutral color are separated and are defined by the 4-channel gray balance curve, while the X-axis represents the Y (luminance) value associated with each color component value. In this way a set of 3 separate gray balance curves associated with the three color channels Cyan, Magenta, and Yellow are plotted as function of Y (luminance), which in the exemplary embodiment proceeds from 1 (light) to 0 (dark) along the X-axis.

In the exemplary embodiment, a K-channel curve is derived from the color engineering experience of the inventors and is included within the 4-channel gray balance curve of FIG. 23. The K-channel gray balance curve serves to minimize the influence of the black ink, and to determine final Y-axis values for each color channel (Cyan, Magenta, Yellow) under the condition that Y (luminance) is equal to 0. This determination of color channel end point values is further described in the portion of Appendix C relating to color end point calculation. Introduction of the K-channel has the affect of lowering the values of the remaining CMY color channels as a luminance value of 0 is approached along the X-axis, since less color is used in order to account for the presence of black ink. The curve of FIG. 23 associated with each color channel may be constructed through spline interpolation by generating a first segment from the origin to the first plotted XY coordinate, between the plotted XY coordinates, and from the last XY coordinate to the predicted color end point based on the K channel.

Color Correction

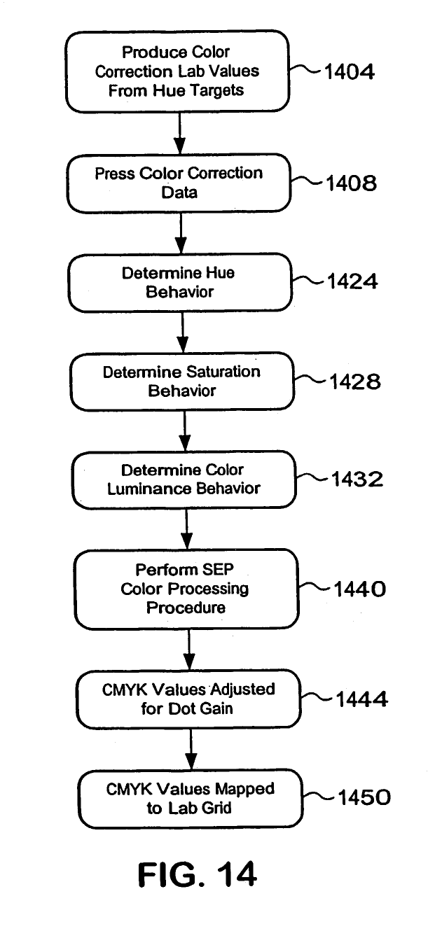

FIG. 14 is a flowchart representative of a color correction process performed during generation of the L*a*b* to CMYK color space transformation incorporated within the press ID profile 74. Referring now to FIG. 14, in a step 1404 a set of L*a*b* color correction values are determined from the predicted hue target percentages set forth in Appendix B and are then converted into predicted YSH data. Specifically, the press CMYK-to-L*a*b* look up table described above is used to determine a set of Hue Balance L*a*b* values using the hue target percentages (Appendix B). The ID creator unit 20 then converts the Hue Balance L*a*b* values into the XYZ color space using, for example, the publicly available conversion formulas set forth in Appendix C. Next, this XYZ color data is transformed into the predicted YSH data using other known formulas set forth in Appendix C.

Referring again to FIG. 14, in a step 1408 a set of press color correction values (Hue, Saturation, and Luminance) are then developed using certain of the 16 previously generated press color correction targets. In particular, 12 of these targets are preferably selected for measurement by a spectrophotometer and the measurement results translated into the XYZ color space, and then into the YSH color space in order to yield measured YSH color correction data. In the exemplary embodiment these 12 patches consist of combinations of CM, CY, and MY in which the coverage percentage of both colorants within the combination are 100%, 50%, 25%, and 12.5% (e.g., C(100%) M(100%), C(50%) M(50%), and so on).

The ID creator unit 20 then operates to determine hue behavior by graphing the H (hue) values of this predicted YSH data relative (see above step 1404) to dot percentage amount in order to yield hue behavior curves of the type set forth in the exemplary H-Graph representation of FIG. 24 (step 1424). Specifically, the block of 36 target colors within the hue target table of Appendix B which include a C, M, or Y component having a dot coverage of 100% are used to generate the 100% hue correction curve (i.e., the colors within the two columns at the far right of the hue target table of Appendix B). That is, the hue (H) of the measured YSH data for each of these target colors is determined from the associated measured YSH data and plotted as a function of dot percentage (preferable expressed as a range of 0 to 360 degrees rather than the normalized range of 0 to 1). If the printing press 22 were operative to produce patches having perfect hue amounts, the associated measured YSH data would be such that the resulting “correction curves” would be straight lines. However, in practical implementations of the printing press 22 it is common for ink impurities and mechanical imperfections for non-linear measurement results to be obtained. This tends to result in hue correction curves which “wave” about the applicable percentages in the manner illustrated by the exemplary hue correction curves of FIG. 24.

The S-Graph of FIG. 25 may also be used to generally represent the saturation behavior of the printing press 22 for an exemplary set of five dot coverage percentages as determined by the ID creator unit 20. The ID creator unit 20 determines the saturation behavior illustrated by FIG. 25 by graphing the values of H (hue) relative to S (saturation) using the press color correction values (step 1428). In the exemplary embodiment, a set of five blocks of target S values are graphed against the same circular H values at 100%, 87.5%, 75%, 50% and 25%, and these measured values are used to produce interpolated saturation curves from 1%-99% using the spectral prediction formula of Appendix D. Again, if the printing press 22 were capable of producing images having perfect saturation, the resultant saturation behavior graphs produced by the ID creator unit 20 would comprise a set of straight lines. However, imperfections associated with practical implementations of the printer 18 result in measured saturation values may be greater than, less than, or equal to predicted saturation values for each applicable hue value.

A Y-Graph may also be generated by the ID creator unit 20 for the printing press 22 in a manner substantially similar to the procedure described above with reference to the color printer 18 (step 1432).

Referring again to FIG. 14, the ID creator unit 20 executes a SEP color processing procedure using the above-described gray balance curves, and the Y-Graph, S-Graph and H-Graph developed for the printing press 22, in order to transform the measured YSH color correction data (see above step 1408) into CMYK data (step 1440). As is described below, the SEP procedure contemplates transforming the measured YSH color correction data into CMYK color correction data through manipulation of the SEP parameters Hue, Amount and Gray.

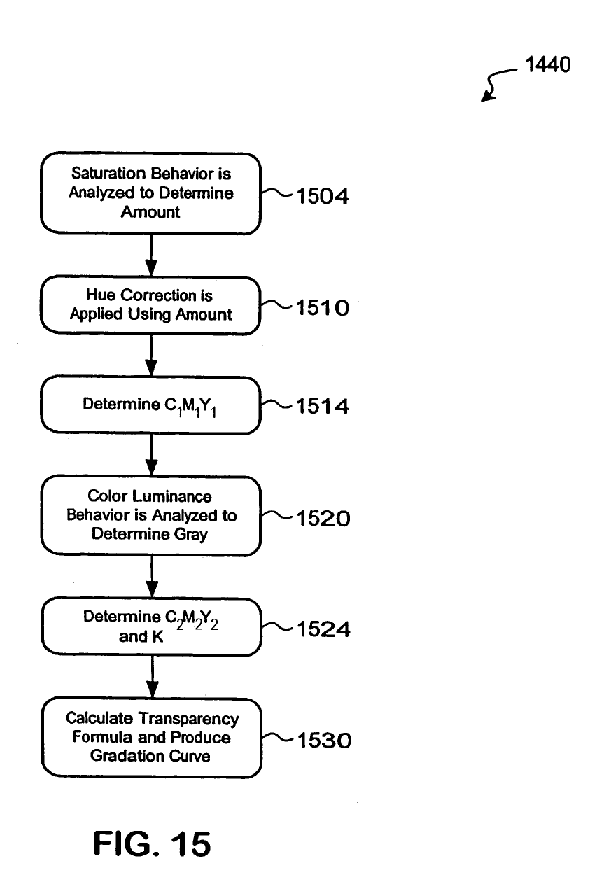

Turning now to FIG. 15, a flowchart is provided which illustratively represents the SEP color processing procedure 1440. As an initial step in the SEP procedure, saturation behavior is analyzed in order to the Amount parameter (step 1504). Specifically, the measured saturation curves from the above-described S-Graph (i.e., the curves corresponding to saturation levels of 100%, 50%, 25% and 12.5%) and the interpolated curves associated with other dot coverage percentages derived therefrom are used to determine an Amount value corresponding to each unit of measured YSH color correction data. Specifically, such an Amount value is determined by reading the saturation curve associated with the same saturation (S) as the given measured YSH color correction value, with the curve being read at the Hue value (H) of such measured YSH color correction value. For example, assuming a measured YSH color correction value having a saturation of 48% (i.e., S=48%) and a hue of 40% (i.e., H=40°), the value of the non-measured 48% saturation curve at 40° would be used for the Amount. For purposes of the present example, it is assumed that this Amount value is equivalent to 47%.

The SEP process continues by application of a hue correction value based upon the Amount quantity obtained above (step 1510). In particular, using the measured and interpolated hue correction curves included within the above-described H-Graph, a new Hue value is determined for each measured YSH color correction value by shifting the original Hue value of such color correction value by the difference between one of such measured/interpolated hue correction curves and a corresponding linear hue correction curve. The measured/interpolated hue correction curve to be used is the one of the measured or interpolated hue correction curves associated with the same coverage percentage as the Amount value obtained above. Accordingly, to extend the above example the 47% non-linear hue correction curve is selected (since in the above example Amount was determined to be equal to 47%) and read at a Hue value of 40° in order to determine a hue correction value. If it is assumed for exemplary purposes that this hue correction value is 49% (i.e., +2% from a linear value of 47%). The difference between these correction values (i.e., 47-49) yields a −2° hue shift value, which when applied to the original H Hue value 38° shifts it to 38°.

Next, the curve of the H-Graph corresponding to 100% saturation is used to determine initial Cyan (C₁), Magenta (M₁), and Yellow (Y₁) values at the shifted original Hue value (step 1514). Continuing with the present example, using a Hue at 38° results in a C₁ of 0%, an M₁ of 39%, and a Y₁ of 100%.

The SEP process is continued by analyzing luminance behavior in order to determine the Gray parameter (step 1520). In particular, using the measured and interpolated luminance correction curves included within the above-described Y-Graph, a Y_{Δ} value is determined for each measured YSH color value by selecting the one of the curves of the Y-Graph associated with the Amount percentage at the original Hue value. The corresponding Gray value may be determined as follows: Gray=Y+(1−Y_{Δ}). Continuing with the present example, Y_{Δ} is the Y-axis value obtained using the curve on the Y-Graph corresponding to a saturation level of 47% (i.e., since Amount is 47%) at the 400 point (the original H value). Assuming for exemplary purposes that the value of Y in the measured YSH color correction data is 0.5, then Y_{Δ}=of 0.78. It follows that the Gray value would be 0.72 (i.e., 0.5+(1−0.78)).

Using the G-Graph, gray balance values Cyan (C₂), Magenta (M₂), Yellow (Y₂) and Black (K) are determined on the basis of the Gray value obtained above (step 1524). In particular, the gray balance C₂M₂Y₂K are determined from the G-Graph at the gray luminance (Y_{g}) level associated with the Gray value. Continuing with the present example, using a Y_{g} of 0.72 (Gray) results in C₂=0.15, M₂=0.20, Y₂=0.22, and K=0. In particular, the C curve of the G-Graph is used to obtain the value of C₂, the M curve of the G-Graph is used to obtain the value of M₂, the Y curve of the G-Graph is used to obtain the value of Y₂, and the K curve of the G-Graph is used to obtain the value of K.

The SEP process is concluded by determining final CMY adjustments based upon a transparency formula and generation of a 4-channel gradation curve (step 1530). In the exemplary embodiment the transparency formula is given by Color₁+(Color2×(1−Color₁)), and is used to determine a set of final CMY adjustments. After translating the initial CMY percentage values to decimal equivalents, the transparency formula is applied in the present example as follows:

C=0+(0.15×(1−0))=0.15 (Cyan)

M=0.39+(0.20×(1−0.39))=0.532 (Magenta)

Y=1.00+(0.22×(1−1))=1.00 (Yellow)

Referring again to FIG. 14, this set of CMYK values are then adjusted for dot gain using the inverse of the dot gain curve derived for each color (step 1444). After being so adjusted for dot gain, these CMYK values are mapped to the normalized L*a*b* grid coordinates created previously (step 1450). The resultant CMYK-to-L*a*b* grid map is stored as a look up table and loaded into the press ID profile 74 (e.g., at tag B2A1).

### Synthesis of Press ID Profile Using Color Space Transformation Information

Turning now to FIG. 16, the process 1040 for synthesizing the press ID profile 74 on the basis of the color space transformation information discussed above is described in greater detail. In the exemplary embodiment the format of the press ID profile 74 will adhere to the requirements for a ColorSpace Conversion Profile set forth in the Specification File Format for Color Profiles promulgated by the International Color Consortium (ICC), which currently is defined by version ICC.1:2001-04 (the “Specification”).

The process of synthesizing the press ID profile 74 is initiated by building a press ID profile header (step 1604). The Specification contemplates a set of 15 required fields, each of which is incorporated within the printer ID profile header and described below:

Profile Size: The total size of the press ID profile 74 (in bytes) as calculated by the ID creator unit 20.

Color Management Model (CMM) Type Signature: A parameter required in connection with ColorSynch processing using a Heidelberg Druck Machine (“HDM”).

Profile Version: The Revision Number of the ICC Specification to which the printer ID profile adheres (currently “2.4.0”).

Profile/Device Class Signature: “ptr” (Output Device Profile)

Color Space Signature: “CMYK”

Profile Connection Space Signature: “L*a*b*”

Creation Date: The date/time value (generated by the ID creator unit 20) of the date of first creation of the press ID profile 74. The date/time value is expressed in terms of year, month, day, hour, minute and second.

Profile File Signature: “ascp” (ICC required value {61637370h})

Primary Platform Signature: “APPL” (for Apple Computer, Inc.)

Profile Flags: “00” (Not embedded, Use anywhere)

Device Manufacturer and Model Signatures: Blank (None)

Attributes: “0000” (Reflective, Glossy, Positive, Color)

Rendering Intent: “0” (Perceptual)

White Point: The X, Y, Z values of the measured white patch.

Profile Creator Signature: Blank (None)

The CMYK-to-L*a*b* look up table derived above is stored within the press ID profile 74 as the ICC Transformation Parameter Structure Tag A2B1 (lut16Type) (step 1608). Similarly, the L*a*b*-to-CMYK look up table derived above is stored within the press ID profile 74 as the ICC Transformation Parameter Structure Tag B2A1 (lut16Type) (step 1612).

Exemplary embodiments of the press ID profile 74 will also incorporate the tags described below in TABLE III. The ID creator unit 20 calculates the size of each tag and will also apply all appropriate tag offsets (step 1616).

TABLE III

| Tag | Signature | Description |
|---|---|---|
| CGX ID | CGX | Used to store private ID creator |
| | | engineering data (i.e., not available to |
| | | the public). |
| Description | desc | Stores a descriptive name for the press |
| | | ID profile 74 (e.g., |
| | | “1280.CXD.3.7.02.icc”) |
| Copyright | cprt | Copyright information |
| White Point | wtpt | Measured White Point's XYZ values. |
| Gray Curve | GRAC | 4-channel (CMYK) curve based on gray |
| | | targets |
| Gradation Curve | GRAD | 4-channel (CMYK) curve based on hue |
| | | targets and adjusted using the SEP color |
| | | process |
| HCL Curve | HCLC | 3-channel curve derived from L*a*b* |
| | | color space |
| CMYK-to-Lab | A2B1* | Color-corrected L*a*b* color space |
| CLUT | | mapped to a CMYK 6 step grid (see |
| | | step 908) |
| Lab-to-CMYK | B2A1* | Color corrected CMYK color space |
| CLUT | | mapped to L*a*b* 33 step grid (see |
| | | step 912) |
| CMYK-to-L*a*b* | Ali | 3-channel L*a*b* input curve that |
| Input Curve | | corresponds to the Lab values in the |
| | | A2B1 tag |
| CMYK-to-L*a*b* | Alo | 4-channel CMYK output curve that |
| Output Curve | | corresponds to the CMYK values in the |
| | | A2B1 tag |
| CMYK-to-L*A*b* | Alh | 3-channel linear YSH curve |
| YSH Curve | | |
| CMYK-to-L*a*b* | !AB1 | A backup of the B2A1 tag used to |
| Backup | | support non-destructive editing by the |
| | | ID creator unit 20. |
| Lab-to-CMYK | Bli | 3-channel L*a*b* input curve that |
| Input Curve | | corresponds to the Lab values in the |
| | | B2A1 tag |
| Lab-to-CMYK | Blo | 4-channel CMYK output curve that |
| Output Curve | | corresponds to the CMYK values in the |
| | | B2A1 tag |
| Lab-to-CMYK | Blh | 3-channel YSH curve produced from |
| YSH Curve | | the hue color targets during the Lab-to- |
| | | CMYK color correction process |
| Lab-to-CMYK | !BA1 | A backup of the B2A1 tag used to |
| Backup | | support non-destructive editing by the |
| | | ID creator unit 20. |

### Operation of RIP

As was mentioned above with reference to FIG. 1, the software-based raster image processor (RIP) 50 executing on the color management unit 16 utilizes a printer identification (“ID”) profile and a press ID profile in converting input image data received from the workstation 36 into the device-dependent color space of the color printer 18. After the input image data is processed by the color management unit 16 on the basis of these stored ID profiles, the resultant processed image data is supplied to the color printer 18 in order that it may print a proof of the image constructed by the workstation 36.

In the embodiment of FIG. 1, the RIP 50 is functionally disposed between the color printer 18 (i.e., a “print engine) and a “front end” computer such as the workstation 36 capable of running a commercially available software imaging application 52 such as, for example, Adobe Illustrator™. Processing is initiated when the imaging software “prints” a file denominated in a page description language (PDL) to the RIP 50. As is described below, since the RIP 50 has been previously registered with respect to such application 52, invocation of a the standard printing functions of the application results in generation of the PDL to be processed by the RIP 50. It is observed that although in the embodiment of FIG. 1 the RIP 50 is disposed within the color management unit 16, in other implementations the RIP 50 may incorporated within the workstation 36 or in another processing element in communication therewith.

In accordance with the invention, the RIP 50 is designed to utilize a pair of ID Profiles generated in the manner described above (e.g., a Printer ID Profile and a Press ID Profile) in establishing relationships between device-dependent and device-independent color spaces in a way that enables improved color printing. For purposes of explanation, the RIP 50 may be considered to utilize the CMYK-to-independent color transformations of the Press ID Profile to transform the input PDL data into device-independent data. The RIP 50 then uses the independent-to-CMYK color transformations of the Printer ID Profile in order to transform this device-independent data into device-dependent data specific to a particular output printing device. Specifically, the RIP 50 processes device-dependent PDL image data in order to create raster data for each color inherent therein using the Press ID and Printer ID Profiles. The typically results in generation of a raster data bit map for each color, each of which may be referred to as a color separation. Each color separation may be transferred from the RIP 50 to an output device (e.g., the color printer 18) over a high speed communication link.

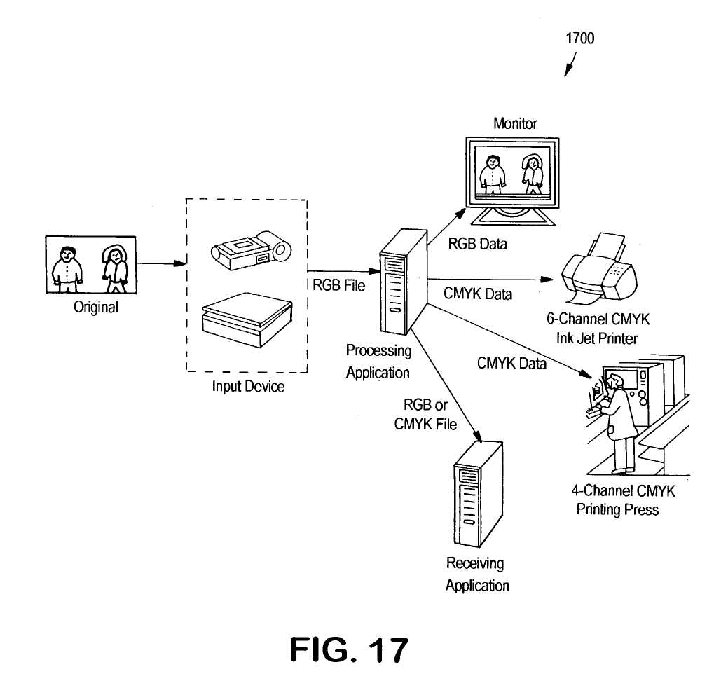

The operation of the RIP 50 may be further appreciated with reference to FIG. 17, which depicts an exemplary system 1700 in which color transformation may be effected in accordance with the present invention. In the system 1700 of FIG. 17, the various user devices and applications are configured to operate within the RGB and CMYK color spaces. However, the applications and devices interpret and translate color somewhat differently. For example, while most printing presses use 4-channel CMYK to produce color images, many ink jet printers also utilize Light Cyan and Light Magenta inks and thereby operate in a 6-channel CMYK color space. In accordance with the invention, the RIP 50 of present invention employs a device-independent color spaces in order to provide an improved approach of translating from a input user color space to an output user color space. A number of abstract color spaces may be employed, and each may be defined by mathematical relationships relative to commonly known device-dependent color spaces (e.g., RGB and CMYK). The present invention leverages the approach to cross-platform color management developed by the International Color Consortium (ICC) through device profiles which are consistent with the format promulgated by the ICC, but which contain the additional transformation information described in the preceding sections. This additional transformation is used by the RIP 50 in effecting an improved transformation between device-dependent input and output color spaces.

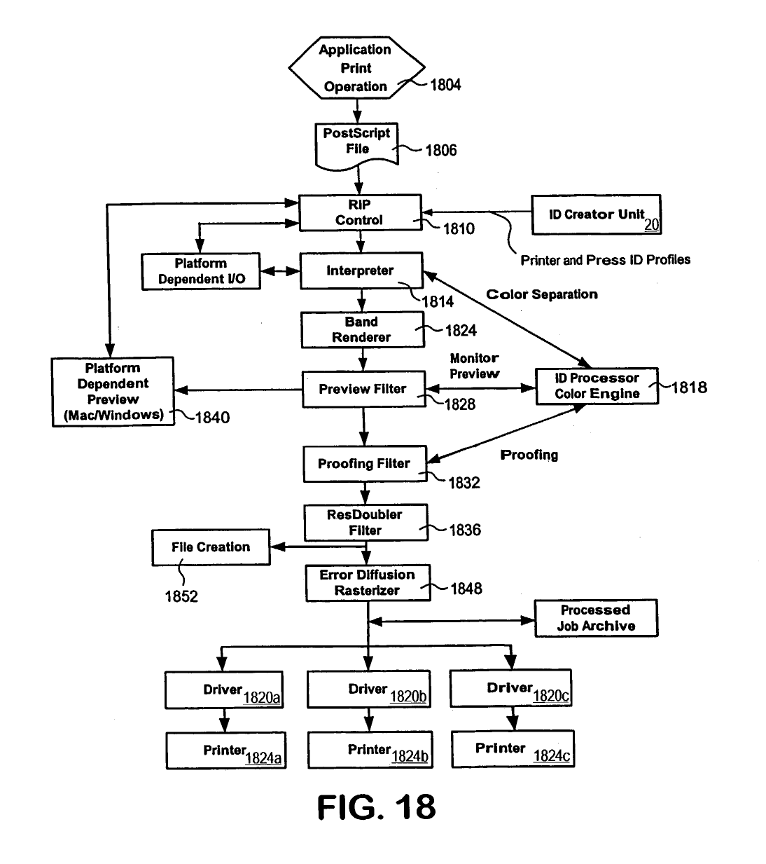

Turning now to FIG. 18, an illustrative representation is provided of the manner in which work flow progresses among the primary functional components of the RIP 50 and of the relationship of such components to various external elements. As shown, RIP processing is initiated when the imaging application 52 executing on the workstation 36 performs a print operation directed to the RIP pursuant to which a PDL file 1806 is generated (step 1804). Next, a number of procedures necessary to generally configured the RIP 50 (e.g., establish internal and external interfaces, set image and font parameters relevant to the processing of color data) are performed by a RIP control module 1810. Execution of these procedures by the RIP control module 1810 also entails establishing a print driver 1820 corresponding to the printer 1824 of interest. Once this has been accomplished, a specific instance of the RIP 50 associated with the particular printer 1824 and driver 1820 of interest (i.e., a “RIP Queue”) is published to the operating system 64 of the color management unit 16. This allows the imaging application 52 to register the RIP Queue as an available printing device.

During an RIP initialization process performed by the RIP control module 1810, a user designates a printer ID profile corresponding to each RIP Queue of interest and may optionally designate a press ID profile corresponding to imaging application 52. As is indicated by FIG. 18, it is assumed that these printer and press ID profiles have been developed by the ID creator unit 20 in the manner described above prior to commencement of the RIP initialization process. In the exemplary embodiment the user also typically designates a public ICC Profile to be used for RGB image processing, and the manner in which RGB images are to be output (i.e., Separation or Wide Gamut). If the Separation mode is selected, it will be required that a press ID profile be selected. Once the PDL file 1806 has been presented to the RIP 60 for processing, the RIP control module 1810 controls the data interfaces between the other functional elements of the RIP 50.

As is illustrated in FIG. 18, the RIP 50 further includes an interpreter module 1814 responsible for translating the vector data within the PDL file 1806 into a data framework amenable to bitmap rendering. The interpreter module 1814 maintains an interface to an ID processor color engine 1818 (described below) in order to enable color data to be translated prior to being rendered.

The color engine 1818 is configured to perform various color processing operations using the selected printer and press ID profiles in order to effect a desired color transformation. In particular, the color engine 1818 may also issue calls to various public transformation applications (e.g., ColorSynch in Macintosh environments, and ICM in Windows environments), in connection with transformation of the color data supplied by the interpreter module 1814. Examples of the type of transformations which may be performed by the color engine 1818 are described below.

Printer CMYK Processing (Printer Profile Used at Input and Output)

In performing this transformation the color engine 1818 executes a color transformation application based upon a pair of printer ID profiles (i.e., a printer input transform construct and a printer output transform construct). A press ID profile is not specified in this case.

CMYK Proof Processing (Press Profile Input—Printer Profile Output)

During this transformation the color engine 1818 executes a color transformation application which utilizes a press input transform construct derived from a press ID profile and a printer output transform construct derived from a printer ID profile. This enables, for example, the CMYK image output produced on a 6-color channel ink jet printer to appear as if it were produced by a 4-color channel press.

RGB Separation Processing (RGB Profile Input—Press Profile Output)

In performing this transformation the color engine 1818 executes a color transformation application based upon a public RGB input transform construct and a press output transform construct derived from a press ID profile. As an example, this transformation would enable an RGB image to be accurately converted into a 4-channel CMYK image.

RGB Wide Gamut Processing (RGB Profile Input—Printer Profile Output)

In performing this transformation the color engine 1818 executes a color transformation application based upon a public RGB input transform construct and a printer output transform construct derived from a printer ID profile. As an example, this enables RGB images to be converted into 6-channel CMYK images.

Preview Processing (Printer or Press Profile Input—Monitor Profile Output)

During this transformation the color engine 1818 executes a color transformation application which utilizes (i) either a printer or press input transform construct derived from a printer or press ID profile, and (ii) an RGB output transform construct corresponding to the screen display of the designated output device. This enables, for example, CMYK images to be converted into RGB images for screen display.

Referring again to FIG. 18, a band renderer module 1824 is responsible for “drawing” a bitmap using the color data processed by the interpreter 1814. In the exemplary embodiment the band renderer 1824 renders the interpreted data provided by the interpreter 1814 in plural sequenced page bands.

The RIP 50 will typically be configured to use a number of filtering operations to modify the bitmap rendered by the band renderer 1824. In the exemplary embodiment, these filtering operations are implemented by a preview filter module 1828, a proofing filter module 1832 and a resolution doubling filter module 1836. The preview filter module 1828, which interfaces with the color engine 1818 and a platform-dependent RIP preview module 1840, functions to enhance the accuracy of image representation. As shown, the proofing filter module 1832 interfaces with the color engine 1818 and is operative to transform CMYK data in way that enables the results of ink-jet printing to accurately resemble the results obtained from a printing press. The resolution doubling filter module 1836 is employed in order to double the resolution of the bitmap produced by the renderer 1824.

As is indicated by FIG. 18, the interpreted and rendered color data is provided to an error diffusion rasterizer module 1848. In operation, the rasterizer module 1848 accepts the interpreted and rendered data and prepares it for the particular driver/printer pair associated with the applicable RIP Queue. In the exemplary embodiment the rasterizer module 1848 processes this data in accordance with an error diffusion algorithm.

The print drivers 1820 serve as interfaces between the RIP 50 and the output printers 1824. The drivers 1820 are responsible for maintaining an open printer interface, receiving the screened data, formatting the data for the interfaced printer 1824, and feeding the formatted data to the printer 1824 for output.

Although the RIP 50 is primarily configured to process input image information provided by graphic applications and provide the resultant formatted data to designated printers, in the exemplary embodiment the RIP 50 also performs a number of ancillary tasks. For example, the RIP 50 may include a file creation module 1852 for generating “pre-screened” files in which color data is stored in a printer-independent format after having been subjected to each of the data processing operations described above (e.g., interpreting, rendering, color transformations). The RIP 50 may also incorporate a processed job archive 1858 in which completed jobs are stored for quick “re-printing” without again being required to be processed by the RIP 50.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following claims and their equivalents define the scope of the invention.

[image]

[image]

[image]

[image]

[image]

[image]

[image]

[image]

[image]

What is claimed is:

1. A method for generating a color space transformation table configured to convert an input color defined in a device-dependent color space of an imaging device into an output color defined in a device-independent color space, said method comprising:
printing a plurality of sets of primary color targets using each of a corresponding plurality of primary colorants of said device-dependent color space, said primary color targets being printed by said imaging device at a selected number of coverage percentages;
measuring target spectra of said primary color targets included within each of said plurality of sets of primary color targets in order to create a plurality of initial spectra values;
calculating a plurality of additional spectra values corresponding to combinations of said primary color targets, each of said additional spectra values being based upon a combination of at least two of said initial spectra values;
transforming said initial spectra values and said additional spectra values into a set of device independent color values defined in said device-independent color space; and
inserting said device independent color values into a color table, said color table establishing a correspondence between ones of said device independent color values and device dependent color values defined with respect to said device-dependent color space.

2. The method of claim 1 wherein said plurality of initial spectra values are created by interpolating measured spectra values obtained by said measuring of said target spectra.

3. The method of claim 1 wherein each of said additional spectra values is generated by multiplying at least two of said initial spectra values.

4. The method of claim 1 further including measuring each of said target spectra at a predetermined number of wavelengths such that a set of said initial spectra is associated with each of said wavelengths.

5. The method of claim 4 wherein each a first of said additional spectra values is determined by multiplying at least two of said initial spectra values associated with a first of said predetermined number of wavelengths and wherein a second of said additional spectra values is determined by multiplying at least another two of said initial spectra values associated with a second of said predetermined number of wavelengths.

6. The method of claim 1 wherein said transforming includes transforming said initial spectra values and said additional spectra values into a set of XYZ color values and converting said set of XYZ color values into a set of L*a*b* color values.

7. The method of claim 1 wherein said device-dependent color space is the CMYK color space and the device independent color space is the L*a*b* color space.

8. The method of claim 1 wherein each of said plurality of sets of primary color targets includes one target patch at each of a predetermined number of coverage percentages.

9. The method of claim 2 wherein said plurality of initial spectra values are selected from among a larger plurality of interpolated spectra values derived from said measured spectra values.

10. A method for generating a color space transformation table configured to convert an input color defined in a device-independent color space into an output color defined in a device-dependent color space of an imaging device, said method comprising:
generating a set of gray balance curves using spectral measurements of a plurality of gray balance targets printed by said imaging device;
generating hue, saturation and luminance behavior curves using spectral measurements of a plurality of hue color targets printed by said imaging device;
deriving a set of device-dependent color values using said hue, saturation and luminance behavior curves and said set of gray balance curves; and
inserting said set of device-dependent color values into a color table, said color table establishing a correspondence between ones of said device-dependent color values and device-independent color values defined by said device-dependent color space.

11. The method of claim 10 further including:
printing said plurality of hue color targets, each of said hue color targets being printed by said imaging device and comprised of one or more primary colorants of said device-dependent color space at predefined coverage percentages; and
measuring spectra of said hue color targets in order to create a plurality of initial hue spectra values.

12. The method of claim 11 further including:
transforming said initial hue spectra values into an initial plurality of device-independent color values defined in said device-independent color space; and
constructing said hue, saturation and luminance behavior curves based upon said initial plurality of device-independent color values.

13. The method of claim 12 wherein said initial plurality of device-independent color values are defined in the XYZ color space, said method further including translating said initial plurality of device-independent color values into the YSH color space.

14. The method of claim 10 further including:
determining an initial plurality of device-dependent color values defined in said device-dependent color space using said hue, saturation and luminance behavior curves; and
adjusting said initial plurality of device-dependent color values using said gray balance curves in order to create said set of device-dependent color values.

15. The method of claim 14 wherein said adjusting includes:
determining an adjustment color value for a first of said initial plurality of device-independent color values, and
modifying said first of said initial plurality of device-independent color values on the basis of adjustment color value using a transparency formula.

16. The method of claim 15 wherein said transparency formula may be expressed as:
Color₁+(Color₂×(1−Color₁))=Color′₁
where Color₁ corresponds to first of said initial plurality of device-independent color values, Color₂ corresponds to said adjustment color value, and where Color′₁ corresponds to said first of said initial plurality of device-independent color values subsequent to adjustment via said transparency formula.

17. The method of claim 10 wherein said spectral measurements of said plurality of gray balance targets are made at multiple wavelengths with respect to each of said gray balance targets.

18. The method of claim 15 wherein said generating a set of gray balance curves includes:
printing said plurality of gray balance targets, each of said gray balance targets being comprised of one or more primary colorants of said device-dependent color space at predefined coverage percentages; and
measuring spectra of said gray balance targets in order to create a plurality of gray balance spectra values.

19. The method of claim 18 further including:
deriving a set of interpolated gray balance spectra values on the basis of selected ones of said plurality of gray balance spectra values; and
transforming said set of interpolated gray balance spectra values into an initial plurality of gray balance color values defined in said device-independent color space.

20. The method of claim 19 further including:
translating said initial plurality of gray balance color values into a set of gray balance color data defined in an additional device-independent color space; and
constructing said gray balance curves based upon said set of gray balance color data, each of said gray balance curves being associated with a primary color of said device-dependent color space.

21. A method of proofing an image using a color printer wherein said image is represented by input image data defined in a device-dependent color space of a press device, said method comprising the steps of:
creating a press profile representative of printing characteristics of said press device;
creating a printer profile representative of printing characteristics of said color printer, said printer profile including
a first color space transformation table establishing a correspondence between device-independent color values and device-dependent color values and a second color space transformation table establishing a correspondence between said device-dependent color values and said device-independent color values;
at least one transverse color curve; and
converting, using said press profile and said-printer profile, said input image data into output image data provided to said color printer.

22. The method of claim 21 wherein said press profile includes a third color space transformation table establishing a correspondence between a device-independent color space and a device-dependent color space of said press device.

23. The method of claim 22 wherein said press profile includes at least one transverse color curve.

24. The method of claim 21 wherein generation of said second color space transformation table includes:
printing a plurality of sets of primary color targets and measuring target spectra of said primary color targets in order to create a plurality of initial spectra values;
calculating a plurality of additional spectra values corresponding to combinations of said primary color targets, each of said additional spectra values being based upon a combination of at least two of said initial spectra values; and
transforming said initial spectra values and said additional spectra values into a set of device independent color values.

25. A profile representative of printing characteristics of a color printer, said profile comprising:
a first color space transformation table establishing a correspondence between a first set of device-independent color values and a first set of device-dependent color values defined in a device-dependent color space of said color printer;
a second color space transformation table establishing a correspondence between a second set of device-dependent color values and a second set of device-independent color values; and
at least one transverse color curve.

26. The profile of claim 25 wherein a set of primary colors are included within said device-dependent color space, said profile further including a set of transverse color curves corresponding to said set of primary colors.

27. The profile of claim 25 wherein said second color space transformation table is derived from a plurality of initial spectra measurement values of a set of target patches of primary colors of said device-dependent color space, and from a plurality of additional spectra measurement values corresponding to combinations of ones of said initial spectra measurement values.

28. The profile of claim 27 wherein said initial spectra measurement values and said additional spectra measurement values are transformed into said second set of device independent color values using a predefined transformation relationship.

29. A method for compensating for a dot gain characteristic of a color printer, said method comprising:
generating a press identification file storing spectral data representative of spectra characterizing at least one colorant utilized by said color printer, said spectral data including spectral target data obtained from targets of said at least one colorant printed over a predefined range of coverage percentages;
computing a dot gain compensation relationship based upon said spectral target data associated with a selected wavelength; and
compensating for said dot gain characteristic during operation of said color printer on the basis of said dot gain compensation relationship.

30. The method of claim 29 further including identifying a most absorbing wavelength n associated with said at least one colorant using said spectral data, said most absorbing wavelength n corresponding to said selected wavelength.

31. The method of claim 30 wherein said computing includes computing a set of ratios, each said ratio being defined by (P_{n,i}/Wₙ) wherein P_{n,i} represents a value of spectral target data associated with an i^{th} one of said coverage percentages at said most absorbing wavelength and Wₙ represents spectral data associated with a substrate target.

32. A system for transforming an input image file produced by an input device into an output image file, said system comprising:
an ID creator unit for generating input device ID profile and an output device ID profile, said input device ID profile including transformation information based upon calculated spectral values derived from combinations of target patch spectral measurements; and
a raster image processor (RIP) for generating said output image file on the basis of said input image file, said input device ID profile and said output device ID profile.

33. The system of claim 32 wherein said input device ID profile includes transformation information relating a first device-dependent color space to a device-independent color space.

34. The system of claim 33 wherein said output device ID profile includes additional transformation information relating said device-independent color space to a second device-dependent color space.
